(19) United States
(12) Patent Application Publication
(10) Pub. No.: US 2024/0200162 A1
(43) Pub. Date: Jun. 20, 2024

(54) NOVEL PROCESS AND FLOTATION CHEMISTRY FOR VALUABLE METAL RECOVERY FROM MUNICIPAL SOLID WASTE INCINERATION (MSWI) ASH

(71) Applicants: Phinix, LLC, Clayton, MO (US); Virginia Tech Intellectual Properties, Inc., Blackburg, VA (US)

(72) Inventors: Subodh Das, Clayton, MO (US); Wencai Zhang, Blackburg, VA (US)

(21) Appl. No.: 18/514,620

(22) Filed: Nov. 20, 2023

Related U.S. Application Data
(60) Provisional application No. 63/426,903, filed on Nov. 21, 2022.

(51) Int. Cl. C22B 7/00; C22B 1/24

(52) U.S. Cl. CPC C22B 7/007; C22B 1/24

(57) ABSTRACT

The present disclosure concerns processes and the combinations thereof for the enrichment and/or isolation of valuable metals from municipal solid waste incineration (MSWI) ash. Included are processes of size separation, froth floatation, magnetic separation, specific gravity separation, chemical separation, as well as the removal of lime. BY utilizing two or more, circuits of treatment are also provided that allow for fractionation of enriched valuable metals(s) from which purification thereof can be readily achieved.

### RELATED APPLICATIONS

This application claims priority to U.S. Provisional Patent Application 63/426,903 filed on Nov. 21, 2022, all of which is hereby incorporated by reference in their entirety.

### GOVERNMENT SUPPORT

This invention was made with Government support under grant DE-AR0001397 awarded by the Department of Energy. The Government has certain rights in the invention.

### FIELD OF THE INVENTION

The present disclosure relates generally to the field of metal recovery from solid waste.

### BACKGROUND

Municipal solid waste (MSW) is a mixture of various solid wastes that are generated by human activities, primarily comprised of food waste, paper, biomass, glass, metals, plastics, rubber, and textiles. The combustion of MSW in incinerators allows the recovery of thermal energy together with decreases in the volume by more than 90%. However, the incineration of one tonne of MSW yields about 300 kg of bottom ash and 30 kg of fly ash, which normally contain hazardous pollutants (e.g., heavy metals). Therefore, municipal solid waste incineration (MSWI) ash is currently managed with methods such as solidification with cement-based materials. In addition to the hazardous components described above, MSWI ash also contains critical metals (e.g., Ti, Ni, Co, Mn, Sn, V, Zn) and other valuable metals (e.g., Fe, Cu). According to the data from EPA, MSW production in the U.S. fluctuated from year to year but generally ranged between 250 ton 300 million tons annually. Out of this total, approximately 12-13% of the waste was processed through combustion in waste-to-energy facilities. Consequently, this resulted in the annual production of approximately 10-13 million tons of MSWI ash. This represents a good source of critical metals and other valuable metals.

MSWI ash presents several noteworthy characteristics that introduce challenges in the recovery of valuable metals and generate high-grade products from it. Firstly, MSWI ash has high alkalinity since lime is heavily used in waste-to-energy plants for pollution control and heavy metal stabilization. Therefore, attempting to directly leach valuable metals from MSWI ash using acid leaching would lead to an exceptionally high consumption of acid, and additionally, the heavy metals contained in MSWI ash would be mobilized, causing environmental pollution. Secondly, the composition of MSWI ash is complex, and it contains many different types of valuable metals and considerable amounts of contaminant elements, such as Al, Si, Ca, and Na. This characteristic poses an unfavorable condition for the concentration, purification, and separation of valuable metals to generate high-grade products. Lastly, MSWI ash contains certain components, such as sodalite, which readily dissolved in water, necessitating significant water treatment efforts when processing it for valuable metal recovery. All these factors make valuable metal recovery from MSWI a challenging endeavor.

In most waste-to-energy facilities, only relatively large chunks or pieces of metals are recovered from MSWI ash through dry separation technologies, while the majority of MSWI ash and the valuable metals contained therein are disposed of in landfills. However, a large amount of valuable metals are lost due to the inefficiency of dry physical separation in processing fine particles. A need therefore exists for an approach to recover valuable elements from the ash without incurring the negative environmental consequences.

The final deposition and fate of MSWI bottom ash and fly ash is a long-studied topic. While landfilling is common practice, concerns exist on the direct disposal of incineration residues due to the high potential release of pollutants into the environment. For example, studies have shown that MSWI ashes, particularly fly ash, contains notable amounts of toxic heavy metals and organic pollutants [9]. The toxic heavy metal concentrations in fly ash have been shown to be much higher than those in bottom ash, due to the attachment of metal chlorides to the fly ash particles during air pollution control process [10]. As a result, MSWI fly ash must be treated prior to disposal to reduce potential environmental impact. Common treatment approaches that have been proposed include separation processes, solidification/stabilization, and thermal treatment [11,12]. Bottom ash is primarily composed of silicon, calcium, iron, and sodium. This more favorable composition has prompted consideration of revalorization of the ash as secondary construction and building materials, such as cement replacement and coarse aggregates. Unfortunately, the commercial use of bottom ash in this application is limited due to its chemical and physical properties as well as the lack of a clear economic benefit. Given these limitations, most bottom ash is left unused and landfilled [13].

The presence of valuable metals, including rare earth elements (REEs) and other critical minerals, in MSWI bottom ash has been reported in many publications [e.g. 14-16]. During incineration, more than 80% of the metals comprised in MSW are partitioned to bottom ash. As reported in the literature, the content of ferrous and non-ferrous metals present in bottom ash ranges from 7-15% and 1-2% by weight, respectively, despite varies in the composition of received materials for incineration [17,18]. While the valuable metal concentrations in MSWI bottom ash may be lower than those of commercial metallic ores, ash has many notable advantages as a commodity feedstock, including near-zero mining costs, source abundance, and the diversity of metal species present in the material. Moreover, the recovery of metal from these waste sources can better promote the circular economy, alleviate resource scarcity stress, and ensure a robust and sustainable supply chain.

Many studies have been conducted to recover valuable metals from MSW bottom ash using various approaches, such as magnetic separation [19,20], sorting [21], eddy current separation [19,21], and gravity separation [22,23]. These techniques have been comprehensively reviewed in a recent article and the salient findings are summarized here. The iron scraps and fine magnetic particles (e.g., iron oxides) can be effectively recovered from bottom ash using magnetic belt or drum separators. Eddy current separation is primarily used to recover non-ferrous metals, such as aluminum, copper, and alloys from MSWI bottom ash; however, pretreatments are often required prior to the separation. Particle moisture, shape and density, and position on the conveyor belt can affect the efficiency of eddy current separators [24,25]. Sensor-based sorting technologies like electromagnetic sensors, X-ray fluorescence sensors, and optical sensors have also been applied, which can identify and segregate all kinds of metals and glass particles [26]. These sensor systems require high computing power, and significant costs occur for complex systems; therefore, the sensor systems are normally used for separating materials of high economic value [27]. In some cases, the fine ash or mineral particle coatings on the desired metals deteriorate the sensitivity of available sensors, resulting in unsatisfactory recovery performance [21,28]. Given the different densities between metal compounds (2.6-2.7 kg/dm³) and bulk ash fraction (1.0-1.1 kg/dm³), gravity separation has been employed as a viable approach to improve the recovery of valuable metals from MSWI bottom ash [29]. 70% of non-ferrous metals present in the MSWI bottom ash were recovered from particles with a size of 0.5-2 mm when using an air table gravity separator [30]. While gravity separation is usually inefficient for finer particles, enhanced gravity separators, such as centrifugal concentrators, can be used to promote effective separation for particles below 0.5 mm [23]. By integrating the various separation approaches, several different process circuits have been designed for metal recovery from MSWI bottom ash [19,24].

Unfortunately, current processing methods and the development of the recovering circuits were governed by technical aspects of the separation rather than economic viability of the final process flowsheet. In order to maximize economic benefits, priority in the process design should be given to the most economically valuable metals rather than the broad group of metals (e.g., ferrous and non-ferrous metals). When designing a processing circuit for metal recovery from MSWI bottom ash, more attention needs to be paid to the valuable metals from both the technical and economic aspects, which can not only mitigate the environmental issues but also generate high economic return.

### SUMMARY OF THE INVENTION

The present disclosure concerns characterization and valuable metal recovery from MSWI ash. In some aspects, the present disclosure concerns combinations of various enriching steps in recovering valuable metals from MSWI ash, including size classification, froth flotation, magnetic separation, gravity separation, acid leaching, selective precipitation, solvent extraction, among others. By evaluating the various technologies and combing with metal recovery processes used by the waste-to-energy industry, the present disclosure provides processes integrating physical and chemical processing. As FIG. 1 illustrates, the process includes four parts: dry physical separation (part 1), wet physical separation (part 2), chemical leaching (part 3), and chemical separation (part 4).

Part 1 is currently used to recover relatively large chunks and pieces of metals by dry physical separation technologies, such as eddy current, sorting, and dry magnetic separation. After the dry physical separation process, the remaining MSWI ash is ground and introduced into part 2. Different wet physical separation techniques, including froth flotation, wet magnetic separation, and density separation, are utilized in part 2 to beneficiate valuable from the MSWI ash, leading to several major concentrates enriched in nonferrous metals (Cu, Zn, Ni, and Sn; Co is also included given its similar beneficiation behavior as the nonferrous metals), ferrous metals, and titanium, respectively. In addition, water is reused in part 2 by dewatering the solid products leaving the circuit. The concentrates are fed to chemical leaching processes in part 3 to dissolve valuable metals from the solids into solution. Different leaching methods are applied due to the differences in the leaching characteristics of the concentrates. Subsequently, the obtained leachates are processed in part 4 using different chemical separation methods, such as solvent extraction, precipitation, and adsorption, to separate and purify the valuable metals into high-purity products.

Besides the integrated processing circuit presented in FIG. 1, the circuit itself includes several innovative concepts and technologies to provide sustainable recovery of valuable metals from MSWI ash, such as (1) a reagent scheme for the flotation of nonferrous metals under high alkalinity conditions, (2) a lime removal technology (carbonation/flotation) to reduce acid consumption, (3) integration of different physical separation mechanisms to achieve concentration and pre-separation of the valuable metals, (4) use of different leaching methods for the different concentrates to maximize leaching efficiencies.

A 1^{st} aspect of the present disclosure, either alone or in combination with any other aspect relates to a method to concentrate one or metals from a municipal solid waste incineration (MSWI) ash comprising at least one step selected from:
a. reducing the MSWI ash in size by crushing and sizing particles thereof from about 100 to about 400 mesh;
b. adding the MSWI ash in a froth floatation solution to separate the MSWI ash in a froth floating fraction and a tailings fraction, wherein the froth floatation solution comprises a sulfide and a cationic collector;
c. contact of the MSWI ash with a magnetic field to provide a magnetic fraction of the ash and a non-magnetic fraction of the ash;
d. adding the MSWI ash to a float/sink solution with a specific gravity of 2.4-3.0 to provide a float fraction and a sink fraction;
e. placing the MSWI ash in an aqueous solution and treating with a gas comprised of carbon dioxide to generate calcite-coated lime;
f. treating the ash with a leaching solution to provide a leachate; or
g. preparing a chemically separated fraction of the ash by solvent extraction, ion-exchange, selective precipitation, or passage through a membrane.

A 2^{nd} aspect of the present disclosure, either alone or in combination with any other aspect, relates the method of the 1^{st} aspect, wherein at least two of the steps are performed.

A 3^{rd} aspect of the present disclosure, either alone or in combination with any other aspect, relates the method of the 1^{st} aspect, wherein steps (c) and (d) are performed.

A 4^{th} aspect of the present disclosure, either alone or in combination with any other aspect, relates the method of the 3^{rd} aspect, wherein the non-magnetic fraction is added to the solution of (d).

A 5^{th} aspect of the present disclosure, either alone or in combination with any other aspect, relates the method of the 1^{st} aspect, wherein steps (a), (b), (f), and (g).

A 6^{th} aspect of the present disclosure, either alone or in combination with any other aspect, relates the method of the 1^{st} aspect, wherein (e) is performed before any other step.

A 7^{th} aspect of the present disclosure, either alone or in combination with any other aspect, relates the method of the 1^{st} aspect, wherein the step comprises (f) and wherein the leaching solution comprises an acid.

An 8^{th} aspect of the present disclosure, either alone or in combination with any other aspect, relates the method of the 7^{th} aspect, wherein the leaching solution has a pH of 0.0.

A 9^{th} aspect of the present disclosure, either alone or in combination with any other aspect, relates the method of the 8^{th} aspect, further comprising raising the pH of the leachate to precipitate one or more metals therein.

A 10^{th} aspect of the present disclosure, either alone or in combination with any other aspect, relates the method of the 9^{th} aspect, wherein in the pH is raised to 3.5, 5.5, and 10 in three sequential steps, and wherein precipitated metal is isolated from the leachate with sequential step.

An 11^{th} aspect of the present disclosure, either alone or in combination with any other aspect, relates the method of the 1^{st} aspect, wherein the step comprises step (b).

A 12^{th} aspect of the present disclosure, either alone or in combination with any other aspect, relates the method of the 11^{th} aspect, wherein the cationic collector comprises a dodecylamine salt.

A 13^{th} aspect of the present disclosure, either alone or in combination with any other aspect, relates the method of the 11^{th} aspect, wherein the MSWI ash is prepared as a slurry in water, followed by the sequential addition of the sulfide and the cationic collector.

A 14^{th} aspect of the present disclosure, either alone or in combination with any other aspect, relates the method of the 13^{th} aspect, wherein the sulfide is added first to form a layer of metal sulfates.

A 15^{th} aspect of the present disclosure, either alone or in combination with any other aspect, relates the method of the 13^{th} aspect, wherein carbon dioxide is provided to the slurry prior to addition of the sulfide and the cationic collector to generate lime particles that can be removed and/or air is bubbled in the slurry.

A 16^{th} aspect of the present disclosure, either alone or in combination with any other aspect, relates the method of the 1^{st} aspect, wherein 1, wherein step (c) is performed and the non-magnetic fraction is provided into the froth floatation solution of step (b) and the tailings fraction is then added to the float/sink solution of step (d).

A 17^{th} aspect of the present disclosure, either alone or in combination with any other aspect, relates the method of the 1^{st} aspect, wherein the step comprises (e), wherein the MSWI ash is provided to an aqueous solution and the gas is bubbled therein.

An 18^{th} aspect of the present disclosure, either alone or in combination with any other aspect, relates the method of the 17^{th} aspect, wherein after carbonation of the slurry by the gas, sodium oleate is added to the slurry.

A 19^{th} aspect of the present disclosure, either alone or in combination with any other aspect, relates the method of the 18^{th} aspect, wherein methyl isobutyl carbinol (MIBC) is added to the slurry.

### BRIEF DESCRIPTION OF THE DRAWINGS

FIG. 1 shows an overview of a process integrating physical and chemical processing to enhance CMM recovery from MSWI ash.

FIG. 2 shows an XRD pattern obtained from a bottom ash sample.

FIG. 3 shows size fractionation characteristics of the ash: (a, b) enrichment ratios, (c) mass yields, and (d) PRV.

FIG. 4 shows enrichment ratios (a, b) and flotation recoveries (c, d) obtained from flotation tests.

FIG. 5 shows PRV of the flotation concentrates (a) and PRV distributions of the feed ash and the concentrate obtained from FT8 (b).

FIG. 6 shows the enrichment ratio and recovery of valuable metals in (a) the magnetic fraction of the FT8 tailings and (b) the sink product of the non-magnetic fraction.

FIG. 7 shows a schematic showing the carbonation/flotation process for lime removal.

FIG. 8 shows magnetic separation (a) and gravity separation (b) performance of the MSWI ash with particles coarser than 100 mesh being removed.

FIG. 9 shows beneficiation circuits for upgrading valuable metals from MSWI bottom ash.

FIG. 10 shows leaching recovery of the valuable elements with (a) 0.5 M and (b) 1.0 M HCl.

FIG. 11 shows a general overview of the process circuit for producing high-grade Ti, Sc, Fe, Mn, Co, Ni, Cu and Zn products from MSWI bottom ash.

FIG. 12 shows a process flowsheet for producing high purity products of Cu, Zn, Mn, Co, and Ni from MSWI.

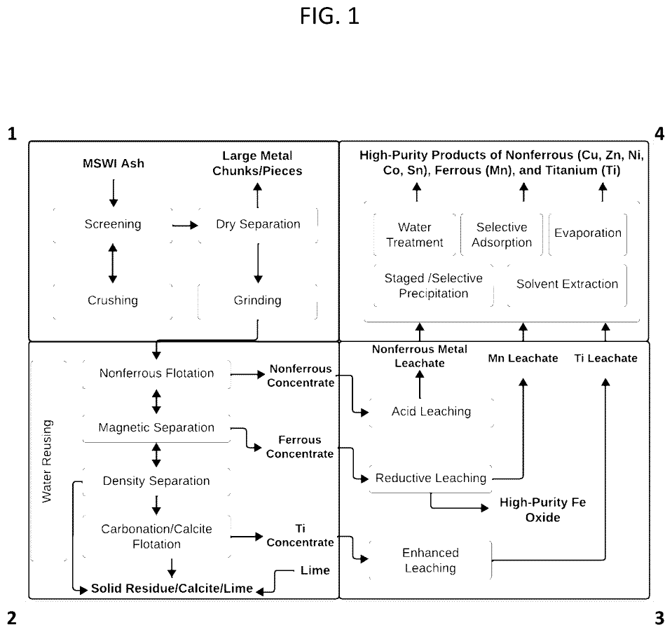

### DETAILED DESCRIPTION

The present invention relates to an integrated circuit that integrates physical and chemical processing to maximize the recovery of valuable metals from municipal solid waste incineration (MSWI) ash. In some aspects, the present disclosure concerns a circuit that utilizes different and varying modes to separate metals from the ash. In some aspects, the circuit allows for varying physical properties of metals in the ash to enrich and/or isolate from other materials and metals in the ash. In some aspects, the circuit may include at last one of a dry size separation step, a nonferrous floatation step, a magnetic separation step, a density separation step, and/or a carbonation or calcite floatation step. As described herein, dry separation allows for metals to enrich based on ash particle size. As described herein, nonferrous floatation allows for nonferrous metal to concentrate. As described herein, magnetic separation allows for ferrous metals to concentrate. As described herein, allows for

Municipal solid waste (MSW) is a mixture of various solid wastes that are generated by human activities and is primarily comprised of food waste, paper, biomass, glass, metals, plastics, rubber, and textiles [1,2]. Municipal solid waste incineration (MSWI) is a common technology used to reduce the volume of MSW, with overall volume reductions as high as 90% or more in some cases [5,6]. MSWI also provides an opportunity for thermal energy recovery, further incentivizing the approach. Byproducts from the MSWI process include fly ash (˜1-3 wt. %) and bottom ash (˜25-30 wt. %), which are classified based on collection positions and residue properties.

To address the limitations in recovering elemental materials, the present disclosure provides a series of steps that allow for recovery of the most valuable metals in a MSWI bottom ash. As set forth in the working examples, initial assays of the material were used to determine the potential recoverable values (PRV, also value (e.g. dollar) per weight (e.g. ton or tonne)), and results of this analysis showed that Ti, Sc, Fe, Cu, and Zn were the most valuable target metals. Size fractionation, froth flotation, magnetic separation, and gravity separation tests were performed on the sample, and the separation performance was evaluated by enrichment ratio, recovery, and PRV of the recovered products. This allowed for several beneficiation circuits to be designed based on the effectiveness of different separation methods for the valuable metals. Furthermore, as also set forth in the working examples herein, the leachability of the valuable metals was determined by acid leaching tests, which provides guidance on the application of hydrometallurgical approaches to recover and purify the valuable metals from the various beneficiation products. The present disclosure accordingly provides for valuable metal recovery from both the technical and economic aspects, which provides for comprehensive utilization of MSWI bottom ash.

### Patent Description

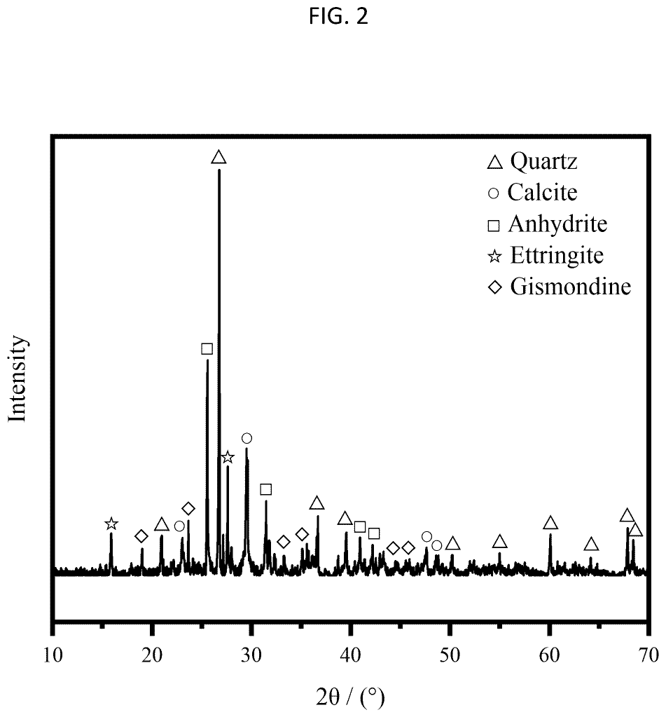

As described herein, the bottom ash from MSWI includes predominant mineral phases of quartz (SiO₂), anhydrite (CaSO₄), and calcite (CaCO₃), with ettringite (Ca₆Al₂(SO₄)₃(OH)₁₂·26H₂O) and gismondine (CaAl₂Si₂O₈·4H₂O) present in more minor amounts. As set forthn in the Examples, a sample of MSWI was assessed for the presence of valuable metals. The XRD pattern of the MSWI bottom ash sample is shown in FIG. 2. Elemental contents shown in Table 1 show that Si with a content up to 18% was the most abundant element, which agrees with the XRD analysis shown in FIG. 2. Despite the relatively high quantities of Fe (7.5%), the characteristic peaks of Fe-bearing phases were not detected in the XRD spectrum, indicating that iron exists within the ash as a poorly crystallized material, in amorphous phases, and/or as substitutions in primary phases [36].

In addition to the major metals, the MSWI ash analysis also contained certain trace elements, such as V, Co, Ni, and Sn. The total REE (TREE) content was around 36 mg/kg, which primarily consists of Sc and Ce (25.3 mg/kg and 7.2 mg/kg, respectively). Some of the elements shown in Table 1, such as Zn, Mn, V, Co, Ni, Sn, and REEs, have been identified as critical elements by the U.S. Department of Interior [37], suggesting that the MSWI ash is a promising source of critical elements.

To develop a process for recovering valuable metals from the material, it is critical to understand the contribution of individual metal to the overall value of the material. The elemental contents shown in Table 1 and the current standard metal prices listed in Table S1 were used to determine the PRV of metals contained within one metric ton of the MSWI bottom ash. (The unit value of each metal is estimated based on multiple price references collected from authoritative online datasets or vendor quotations, and the original sources are listed in the supporting information.) Some elements such as Na, K, and Ca were not considered due to their natural abundance. As Table 2 shows, PRV of the overall material was around 483 $/ton, which is primarily contributed by Ti (44.1%), Sc (28.9%), Fe (11.5%), Cu (5.3%), and Zn (3.5%). Although Mn, Co, Ni, Sn, and V only accounted for 4.7% of the PRV of the overall material, they should be considered along with Ti, Sc, Fe, Cu, and Zn as valuable elements in the recovery process, because of their criticality to high-tech products and clean energy industries [38,39].

TABLE 1
Elemental contents of major elements, trace elements, and rare earth elements in the MSWI ash.

Major elements

| | Si | Fe | Ca | Na | Mg | Ti | Al | P | K | Mn | Cu | Zn |
|---|---|---|---|---|---|---|---|---|---|---|---|---|
| % | 18 | 7.5 | 5.2 | 1.6 | 1.1 | 1.0 | 1.0 | 0.7 | 0.8 | 0.1 | 0.3 | 0.5 |

| | Trace elements | | | | | | |
|---|---|---|---|---|---|---|---|
| | V | Co | Ni | Sr | Sn | Ba | Ag |
| mg/kg | 70 | 70 | 157 | 321 | 121 | 617 | 8.6 |

| | Rare earth elements | | | | | | | | | | | | | | | | |
|---|---|---|---|---|---|---|---|---|---|---|---|---|---|---|---|---|---|
| | Sc | Y | La | Ce | Pr | Nd | Sm | Eu | Gd | Tb | Dy | Ho | Er | Tm | Yb | Lu | TREE |
| mg/kg | 25.3 | 0.1 | 1.6 | 7.2 | 0.4 | 1.1 | 0.1 | 0.1 | 0.1 | 0.01 | 0.03 | <0.01 | 0.02 | <0.01 | <0.01 | <0.01 | 36 |

TABLE 2
Potential recoverable values and distributions
of metals in the MSWI ash.

| Metals | Fe | Ti | Mn | Cu | Zn | V | Co | Ni | Sr | Sn |
|---|---|---|---|---|---|---|---|---|---|---|
| PRV ($/ton) | 55.6 | 212.7 | 7.7 | 25.5 | 16.9 | 2.5 | 5.0 | 3.1 | 2.2 | 4.7 |
| Distribution | 11.5 | 44.1 | 1.6 | 5.3 | 3.5 | 0.5 | 1.0 | 0.6 | 0.5 | 1.0 |
| (%) | | | | | | | | | | |

| Metals | Ag | Mo | Sc | Other REEs | Total |
|---|---|---|---|---|---|
| PRV ($/ton) | 6.2 | 0.8 | 139.5 | 0.3 | 483 |
| Distribution | 1.3 | 0.2 | 28.9 | 0.1 | 100 |
| (%) | | | | | |

Accordingly, MSWI contains valuable metals, such as Ti, Sc, Fe, Cu, Zn, Mn, Co, Ni, Sn, and V. Therefore, MSWI is a promising source of critical minerals. However, the composition of MSWI ash is complex. For example, MSWI contains a large amount of calcium-bearing minerals, such as calcite and lime, which would require a large amount of acid if chemical leaching is directly applied to extract these metals from the material. In addition, the contents of most valuable metals in MSWI ash are relatively lower compared with conventional ores. Thus, direct chemical leaching of MSWI ash would result in a leaching solution with low concentrations of valuable metals within a complex solution matrix with much higher concentrations of undesired abundant metals. These characteristics make it challenging to achieve satisfactory performance in the downstream chemical separation and purification steps. As set forth herein, a process is provided that utilizes an integrated circuit that includes physical beneficiation, chemical leaching, and chemical processing that overcomes these challenges and allows for the recovery of valuable materials from MSWI ash.

Beneficiation Circuit Design: The most valuable metals comprised in the MSWI ash are Ti, Fe, Cu, and Zn, with notable concentrations of Mn, Co, Ni, Sn, and V, all of which are considered to be critical elements with growing demand in the coming decades.

In some aspects, the present disclosure concerns subjecting MSWI to at least one beneficiation step of: A crushing and size selection; B froth floatation separation; C magnetic separation; D specific gravity separation; E lime removal; F leaching; and, G chemical separation. In some aspects, the circuit may include 2 or more steps, such as (and in any order): AB AC AD AE AF AG BC BD BE BF BG CD CE CF CG DE DF DG EF EG FG ABC ABD ABE ABF ABG ACD ACE ACF ACG ADE ADF ADG AEF AEG AFG BCD BCE BCF BCG BDE BDF BDG BEF BEG BFG CDE CDF CDG CEF CEG DEF DEG EFG ABCD ABCE ABCF ABCG ABDE ABDF ABDG ABEF ABEG ABFG ACDE ACACDF ACDG ACEF ACEG ACFG ADEF ADEG ADFG AEFG BCDE BCDF BCDG BDEF BDEG BDFG BEFG CDEF CDEG CEFG and DEFG. It will be appreciated the any combination of five or more, six or more or all seven of the steps may be utilized. It will also be appreciated that additional steps may be introduced to further refine and/or isolate the metals. As set forth herein, each of the seven steps can enrich or isolate metals from MSWI. Accordingly, combinations of the steps in a circuit can allow for further extraction and/or isolation from other metals and materials in the ash.

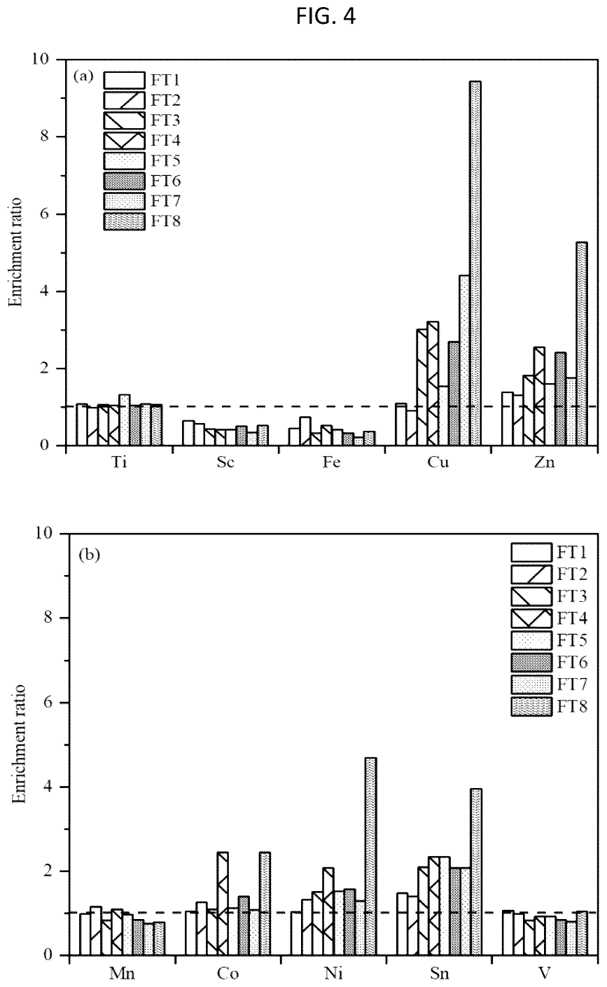

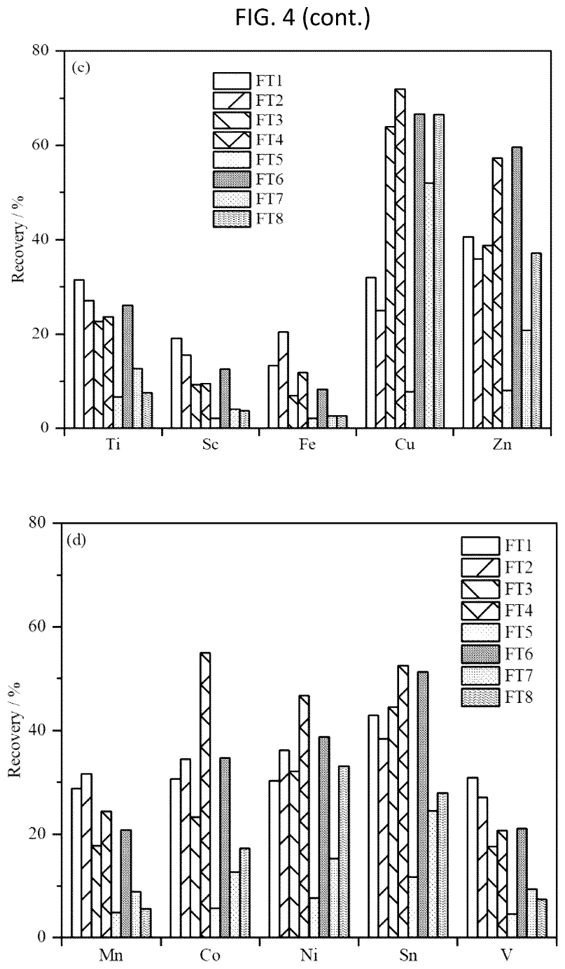

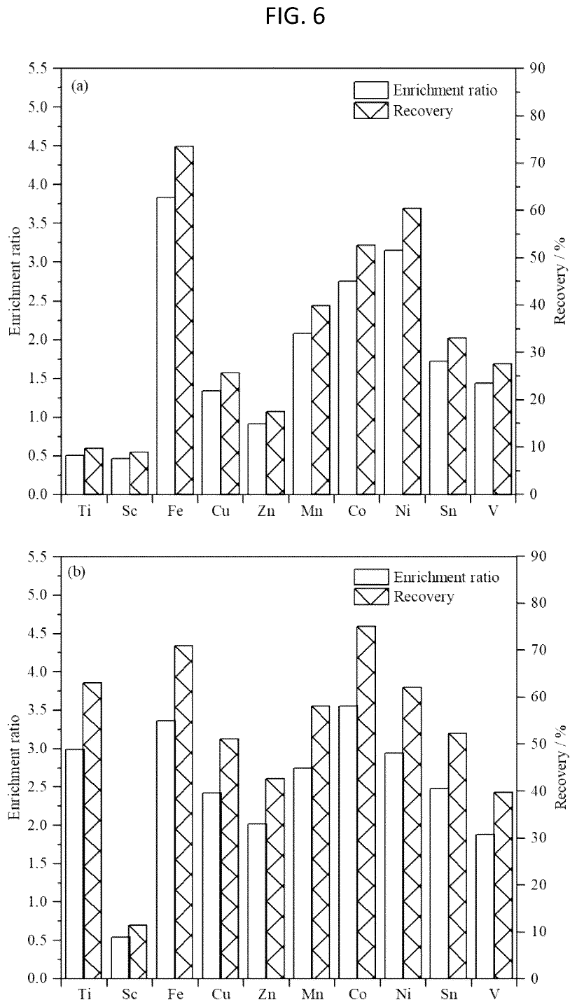

For example, the enrichment ratios presented in FIG. 4(b) and FIG. 6 are summarized in Table 3. As shown, Cu, Zn, Co, Ni, and Sn can be effectively separated from Sc and Fe using froth flotation; yet, Ti and V are not effectively separated from these metals since their enrichment ratios are close to 1.0. Magnetic separation can be used to separated Fe, Mn, Co, Ni, Sn, and V from Ti and Sc; however, because the enrichment ratios of Cu, and Zn is close to 1.0, they cannot be effectively concentrated through magnetic separation. Lastly, gravity separation can concentrate all the valuable metals except Sc in the 2.95 SG sink product.

TABLE 3
Enrichment ratios of the valuable metal
using different beneficiation methods.

| Beneficiation method | Ti | Sc | Fe | Cu | Zn | Mn | Co | Ni | Sn | V |
|---|---|---|---|---|---|---|---|---|---|---|
| Flotation | 1.1 | 0.5 | 0.4 | 9.4 | 5.3 | 0.8 | 2.4 | 4.7 | 4.0 | 1.0 |
| Magnetic | 0.5 | 0.5 | 5.0 | 0.8 | 0.6 | 2.3 | 3.1 | 3.5 | 1.1 | 1.6 |
| separation | | | | | | | | | | |
| Gravity | 1.5 | 0.6 | 2.2 | 1.8 | 1.3 | 1.7 | 2.0 | 1.9 | 1.4 | 1.2 |
| separation | | | | | | | | | | |

For example, based on the efficiency of the different beneficiation methods as described herein, valuable metals in the MSWI bottom ash can be separated and concentrated into Ti-rich, Sc-rich, Fe-rich, and Cu/Zn-rich products. The generation of those products brings several notable benefits: (1) the potential recoverable value of the products is higher than the ash, and as such, the economic value of the ash is improved; (2) the downstream hydrometallurgical processes for obtaining high-grade products of the metals are simplified; (3) the cost of downstream hydrometallurgical processes is reduced by feeding higher grade materials.

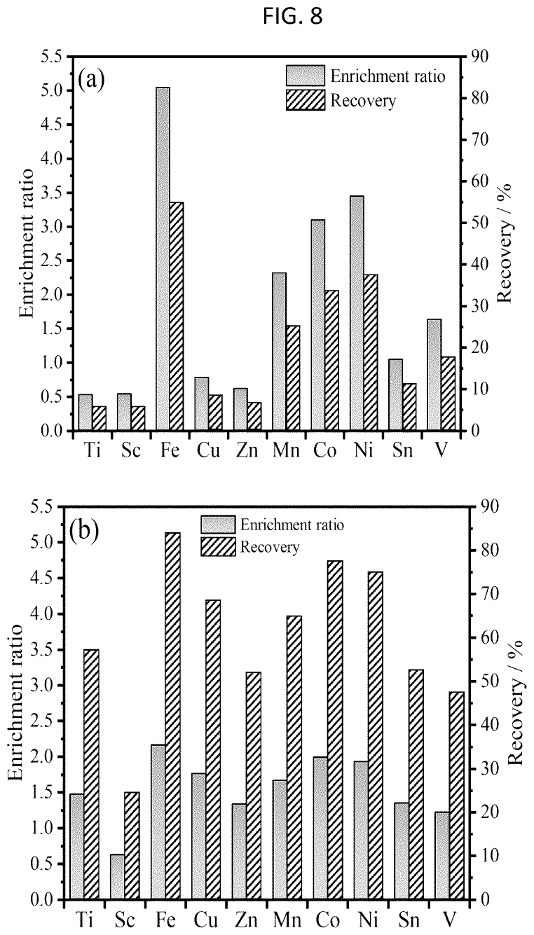

Many beneficiation circuits can be designed to generate Ti-rich, Sc-rich, Fe-rich, and Cu/Zn-rich products from MSWI bottom ash, using various combinations of froth flotation, magnetic separation, and/or gravity separation. Three exemplary circuits (a-c) are presented in FIG. 8. In circuit (a), after being properly pulverized, MSWI ash is sequentially subjected to magnetic separation, froth flotation, and gravity separation, leading to Fe-rich, Cu/Zn-rich, Ti-rich, and Sc-rich products, respectively. Additional results may be obtained using other collectors and regulators, such as anionic-cationic mixed collectors or carboxymethyl cellulose [51,52]; In circuit (b), a second stage of flotation is used to replace gravity separation to generate a Ti-rich product. In circuit (c), the pulverized MSWI ash is subjected to gravity separation first to generate a pre-concentrate of all the valuable metals except Sc. Then, the pre-concentrate is sequentially routed to magnetic separation and froth flotation to generate Fe-rich, Cu/Zn-rich, and Ti-rich products. Sc-rich products can be obtained from all the three circuits since Sc tends to segregate from other valuable metals during the beneficiation. Based on the enrichment ratios shown in Table 3, in all the three circuits, Mn, Co, Ni, Sn, and V can be concentrated in the Fe-rich and Cn/Zn-rich products. These metals can be separated from Fe and Cu/Zn via further beneficiation or hydrometallurgical approaches after being leached. Depending on the results of more comprehensive lab-scale investigation, de-sliming is likely required in the circuits to eliminate the adverse effect of ultrafine particles on the beneficiation performance.

Based on the experimental results presented herein of froth flotation, magnetic, and density/specific gravity separation tests, it can be concluded that different valuable metals present in MSWI ash can be beneficiated using different physical separation mechanisms. The sequence of flotation, magnetic, and density separation can be adjusted to optimize the physical beneficiation performance. By physical beneficiation, the valuable metals are concentrated and initially separated. Thus, leaching solutions with relatively high concentrations of valuable metals can be obtained by leaching the physical beneficiation concentrates separately. The cost of physical processing is lower than that of chemical processing. Therefore, the combination of physical and chemical processing can reduce the overall recovery cost of valuable metals from MSWI ash.

Crushing and Size Fractionation: In aspects, the present disclosure includes a step of size fractioning crushed MSWI ash. It will be appreciated that the crushing can occur through a any crushing mechanism and/or machine in the art, such as a jaw crusher, roller crusher, hammer crusher, ball-mill and so on. In some aspects, the MSWI may be crushed through a combination of machines mechanisms, such as a crusher and a mill. In some aspects, the MSWI is crushed until the ash of a desired size or size range. Size reduction and screening allow for the evaluation of the distribution of valuable metals, as there is a deportment of metals with respect to particle size [40]. As set forth in the working examples, sieving tests were performed on MSWI ash to evaluate the size fractionation characteristics of the valuable metals contained in the MSWI bottom ash. As FIG. 2 shows, the enrichment ratios of Sc, Fe, and V showed a decreasing trend as the particle size of the MSWI bottom ash reduced, with enrichment ratios of less than 1 observed in the −400 mesh fraction. This identifies that Sc, Fe, and V are preferentially enriched in the coarse fractions. Fe-bearing phases also mainly occur in coarse fractions as Fe scraps typically originate from the source objects such as iron cans, containers, and thin sheets, or in mineral phases like hematite as a result of the oxidization during combustion [41,42].

Alternatively, the enrichment ratio of Zn was approximately 1.4 in the −400 mesh fraction and less than 1.0 in the other fractions, indicating that Zn enriches in the finer fractions. Cu, Mn, Co, Ni, and Sn show enrichment ratios of greater than 1.0 in both the coarse and fine fractions, primarily due to the relatively low contents in the middle size fractions. This identifies that the finest particles contribute a significant fraction of valuable metals, especially Cu, Zn, and Sn, which is attributable to the formation of pure solid melts as micro particles when MSW was treated in the incinerator [42,43]. Unlike the above metals, the enrichment ratio of Ti did not vary considerably in different size fractions. Based on the enrichment ratios, separating the ash into coarse, middle, and fine size fractions provides for certain degrees of concentration of the valuable metals. However, as FIG. 2(d) shows, PRV gradually decreased with decreases in the particle size, and the −400 mesh fraction had the least economic value among the different size fractions while accounting for 34% of the mass of the overall material (FIG. 2(d)).

Accordingly, it is a facet of the present disclosure to include a crushing and/or size fractionation to enrich for desired metals. MSWI ash needs to be crushed and/or ground to a particle size that is acceptable for downstream physical beneficiation. Additionally, certain degrees of enrichment of selected valuable metals can be achieved by size fractionation.

### Froth Flotation:

In some aspects of the present disclosure, the methods for isolating and/or enriching from MSWI includes a step or series of step utilizing froth floatation. It is an aspect of the present disclosure that a novel reagent scheme for froth floatation, namely with a cationic collector and a sulfide compound, is provided to efficiently beneficiate nonferrous metals from MSWI ash. A sulfide compound (e.g., metal sulfide such as sodium sulfide) is added to react with the surface to form nonferrous metal sulfides, which exhibit a strong affinity for cationic collectors. Then, a cationic collector, such as sodium dodecylamine, is added to make particles enriched in nonferrous metals hydrophobic, thereby being selectively floated once air bubbles are introduced. It is noteworthy that this reagent scheme is suitable for high alkalinity conditions. As such, pH adjustment is not required for the flotation beneficiation of nonferrous metals from MSWI ash. In other aspects, the pH may be adjusted

As set forth in the working Examples herein, flotation tests identified that valuable metals can be concentrated and the PRV of the ash can be improved through flotation. As Table 4 shows, different collectors were used, including potassium ethylxanthate, sodium oleate, an amine collector, such as Lilaflo D817M, and sodium dodecylamine. (Lilaflo D817M is a typical kind of amine collector that has been employed to separate magnetite and coal from quartz through reverse flotation [44,45].) Na₂S is a flotation reagent for mineral sulfidization [46], which was added in selected tests to regulate the surface characteristics of the oxidization forms of valuable metals.

TABLE 4
Experimental conditions used for the flotation tests.

| Test | |
|---|---|
| No. | Conditions |
| FT1 | 1 kg/ton potassium ethylxanthate, pH 10.7 (no pH adjustment) |
| FT2 | 1 kg/ton sodium oleate, pH 10.7 (no pH adjustment) |
| FT3 | 1 kg/ton Na₂S, 0.75 kg/ton Lilaflot D817M, pH 11.0 (no pH |
| | adjustment) |
| FT4 | 2 kg/ton Na₂S, 0.5 kg/ton Lilaflot D817M, pH 11.1 (no pH |
| | adjustment) |
| FT5 | 2 kg/ton sodium oleate, pH 9.0 (pH was adjusted by adding |
| | sulfuric acid) |
| FT6 | 2 kg/ton Na₂S, 0.5 kg/ton sodium dodecylamine, pH 11.1 (no pH |
| | adjustment) |
| FT7 | 2 kg/ton Na₂S, 0.4 kg/ton potassium ethylxanthate, 0.15 kg/ton |
| | sodium dodecylamine, pH 9.5 (pH was adjusted by adding sulfuric |
| | acid) |
| FT8 | De-sliming; 1 kg/ton Na₂S, 0.25 kg/ton sodium dodecylamine (no |
| | pH adjustment) |

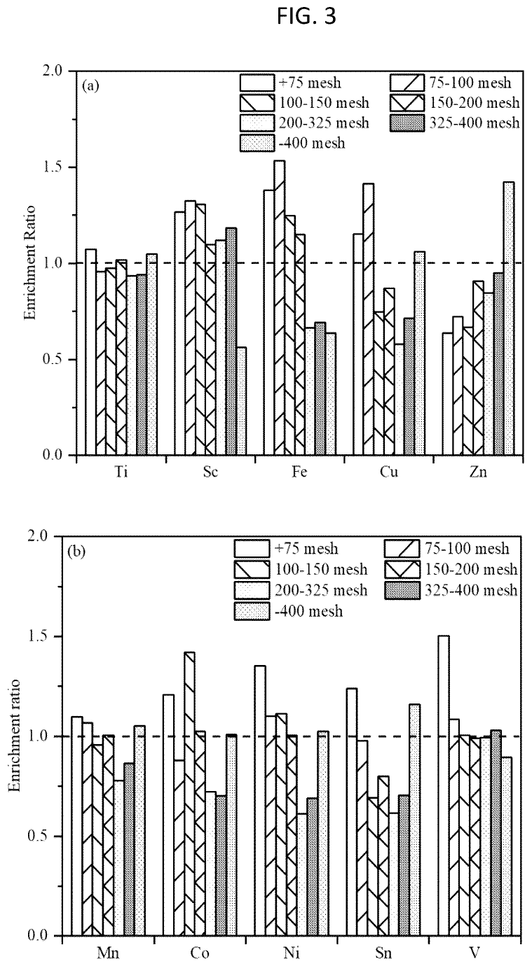

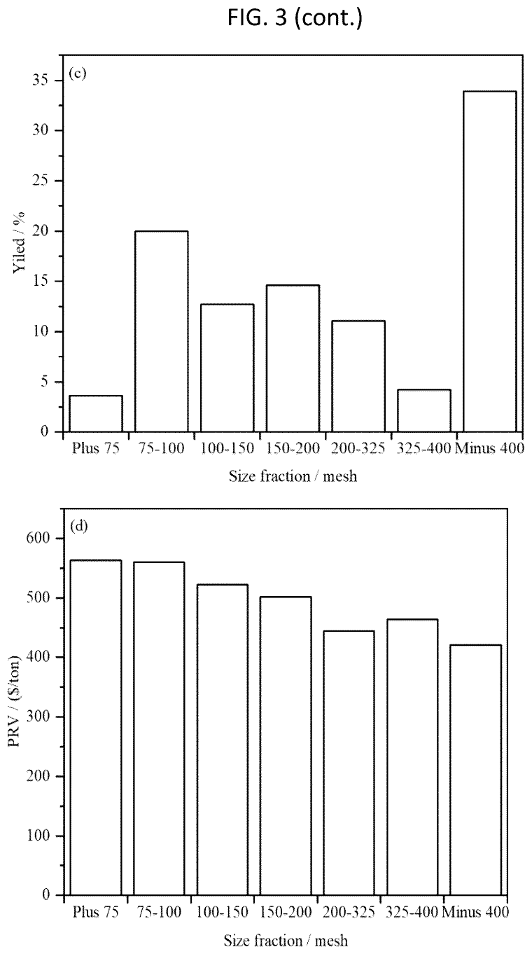

Enrichment ratios and recovery values of the flotation tests are presented in FIG. 3. Under almost all the different flotation conditions listed in Table 3, enrichment ratios greater than 1.0 were obtained for Cu, Zn, Co, Ni, and Sn, indicating that flotation is an effective approach to enrich these valuable metals. Comparisons between the floatation conditions identified that cationic collectors, e.g., Lilaflo D817M (amione collector) and sodium dodecylamine, are more effective than sodium oleate and potassium ethylxanthate. The highest enrichment ratios of 3.2 for Cu, 2.6 for Zn, 2.4 for Co, 2.1 for Ni, and 2.3 for Sn were obtained when Na₂S was used as the regulator and an amine collector (Lilaflo D817M) as the collector without pH adjustment. Under these conditions, around 72% of Cu, 57% of Zn, 55% of Co, 47% of Ni, and 53% of Sn were recovered. A larger enrichment ratio of 4.4 for Cu but lower enrichment ratios for the other valuable metals were obtained when the floatation conditions included a mixture of potassium ethylxanthate and sodium dodecylamine. The highest enrichment ratios of 9.4 for Cu, 5.3 for Zn, 2.4 for Co, 4.7 for Ni, and 4.0 for Sn were obtained using Na₂S and sodium dodecylamine, suggesting that the elimination of fine particles from the feed considerably improved the beneficiation of the valuable metals. A concentrate containing 2.7% Cu, 2.9% Zn, 256 mg/kg Co, 930 mg/kg Ni, and 675 mg/kg Sn was obtained these conditions. The enrichment ratio of Ti, V, and Mn was close to 1.0 in all the tests, indicating that Ti, V, and Mn are not effectively beneficiated using the flotation conditions listed in Table 3. Unlike Ti, V, Mn, Cu, Zn, Co, Ni, and Sn, the enrichment ratio of Sc and Fe was below 1.0 in all the tests, and more frequently less than 0.5. This phenomenon suggests that Sc and Fe are enriched in the flotation tailings instead of the concentrates.

To evaluate the economic benefit of froth flotation process, PRV and PRV distributions of the flotation concentrates were calculated and compared with those of the feed (Table 2). As FIG. 4(a) shows, the PRV of FT8 concentrate was 797 $/ton, which is much higher than that of feed (483 $/ton); therefore, products with higher economic value can be generated through flotation. FIG. 4(b) shows that Ti, Sc, and Fe shared 44.1%, 28.9%, and 11.5% of the total PRV of the feed, respectively; however, for the FT8 concentrate, 44.6% of the total PRV was shared by Cu and Zn. Therefore, the notable increase in PRV brought by flotation is primarily due to the enrichment of Cu and Zn in the concentrate. Slight increases in the PRV distribution of Co, Ni, and Sn also occurred, indicating that Co, Ni, and Sn also contributed to the notable PRV increase.

It is evident that satisfactory beneficiation of the nonferrous metals cannot be achieved using conventional collectors, i.e., xanthates, fatty acids, and amines, in the absence of regulators. Additionally, due to the presence of a large amount of lime in MSWI ash, the slurry during flotation has a high alkalinity, limiting the efficiency of the conventional collectors. Lowering the alkalinity of the slurry by introducing acids is also ineffective due to the consumption of a large amount of acids and the appearance of a large amount of calcium ions caused by lime dissolution. It is an aspect of the present disclosure that a novel reagent scheme for floatation, cationic collector plus a sulfide compound, is provided to efficiently beneficiate nonferrous metals from MSWI ash. A sulfide compound (e.g., sodium sulfide) is added to react with the surface to form nonferrous metal sulfides, which exhibit a strong affinity for cationic collectors. Then, a cationic collector, such as sodium dodecylamine, is added to make particles enriched in nonferrous metals hydrophobic, thereby being selectively floated once air bubbles are introduced. It is noteworthy that this reagent scheme is suitable for high alkalinity conditions. Thus, pH adjustment is not required for the flotation beneficiation of nonferrous metals from MSWI ash.

In some aspects, the present disclosure concerns a froth flotation process based on novel chemistry to recover valuable metals from MSWI ash. In some aspects, froth floatation places MSWI ash or a fraction obtained therefrom in a froth floatation solution that include a collector and a sulfide, such as a metal sulfide. In some aspects, the collectors used for the efficient flotation of valuable metals from MSWI ash are cationic collectors, such as dodecylamine salts. In some aspects, MSWI ash is prepared into a slurry by mixing with water, and chemicals are sequentially added into the slurry to make the surface of particles containing valuable metals hydrophobic. In some aspects, before the addition of collectors, sulfide compounds such as Na₂S are first added to form a layer of valuable metal sulfides on the particles that containing the valuable metals. In some aspects, after the slurry is prepared, the slime fraction of the slurry can be removed before adding chemicals to improve the flotation performance.

Magnetic Separation and/or Gravity Separation:

In some aspects, the present disclosure includes steps of isolation and/or enrichment through magnetic separation. For example, as demonstrated herein, elements such as Cu, Zn, Co, Ni, and Sn are effectively recovered from the MSWI bottom ash via froth flotation. Other elements, such as Ti and Fe were not as enriched. To increase recovery of these elements, the froth flotation tailings can be subjected to magnetic separation.

In some aspects, the MSWI can be subjected to a specific gravity separation. For example as set forth in the working examples, subjecting MSWI or an already fractionated section thereof to a float/sink cutoff with a specific gravity of 2.95 allowed the ash or fraction thereof to further segregate and allow for enrichment of metals.

In some aspects, both magnetic and specific gravity steps can be used. As set forth in the working examples, the froth floatation tailings were subject to magnetic separation and then, the non-magnetic product subjected to a float/sink separation a cutoff gravity of 2.4-3.0 specific gravity (SG). In some aspects, the float/sink solution has an SG of about 2.45, 2.5, 2.65, 2.7, 2.85, 2.9, 2.95, 3.0, 3.05, 3.1, 3.15, 3.2, 3.23, 3.3, and 3.35.

In some aspects, the present disclosure concerns a novel separation processes to concentrate valuable metals from MSWI ash. In some aspects, magnetic separation is used first to recover Fe-rich particles. In some aspects, non-magnetic particles can then be optionally treated with froth floatation procedures as set forth herein. Such can allow for the recovery of Cu and/or ZN rich particles. In some aspects, the tailings from non-magnetic particles are then fed to a flotation arrangement with a float/sink solution of a desired SG for gravity separation to recover particles rich in Ti. While Sc is rich in the low-density product of gravity separation. In some aspects, magnetic separation is used first to recover Fe-rich particles, and the non-magnetic particles are fed to froth flotation to recover particles rich in Cu and Zn, after that, the flotation tailings are fed to a second stage of flotation to recover particles rich in Ti, while Sc is rich in the flotation tailings. In some aspects, gravity separation is used first to recover Sc-rich particles, and the high-density particles are then fed to magnetic separation to recover Fe-rich particles, after that, the non-magnetic particles are fed to flotation to recover particles rich in Cu and Zn, while Ti is rich in the flotation tailings.

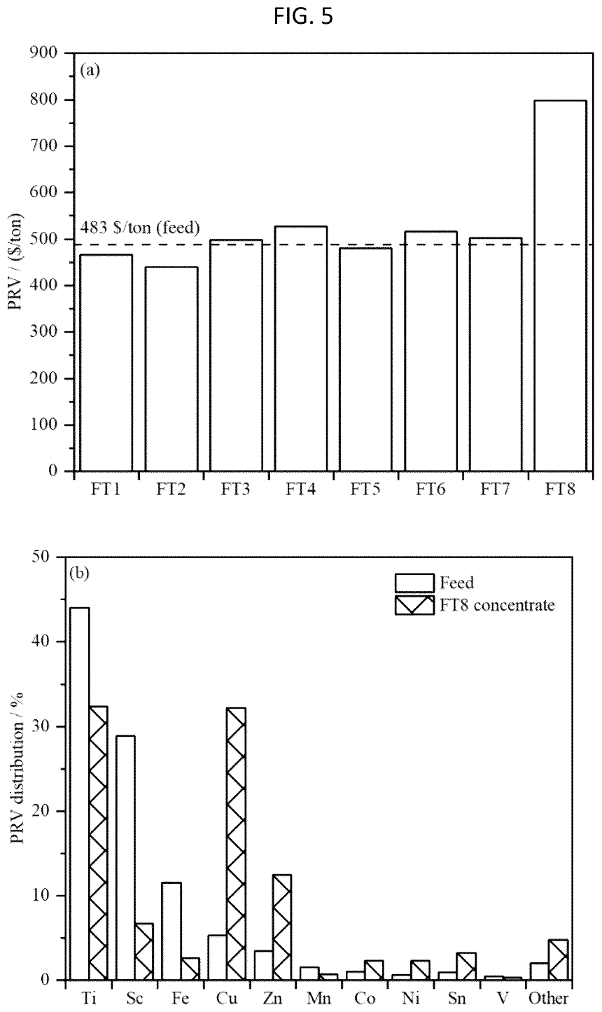

As FIG. 5(a) shows, enrichment of ferro-magnetic metals Fe, Mn, Co, and Ni was achieved in the magnetic fraction. The enrichment ratios of Fe, Mn, Co, and Ni through magnetic separation were found 3.8, 2.0, 2.8, and 3.2, respectively, indicating that these valuable elements existed as or are associated with paramagnetic or ferromagnetic fractions, which can be easily isolated using conventional magnetic field separators [48]. Alternatively, the enrichment ratio of Ti was only 0.5, indicating that the beneficiation of Ti cannot be achieved by magnetic separation, which is due to the non-magnetic nature of pure titanium and titanium alloys [49].

The non-magnetic fraction of flotation tailings was subjected to a float/sink cutoff. As seen in the working examples, two products, 2.95 SG sink and 2.95 SG float, were obtained. As FIG. 5(b) shows, the enrichment ratio of Ti in the 2.95 SG sink product was around 3.0, indicating that the Ti in the non-magnetic fraction can be effectively recovered through gravity separation as a result of the higher bulk density of Ti-bearing materials in MSWI bottom ash [50]. Apart from Ti, all the other valuable metals except Sc were also concentrated in the 2.95 SG sink product. The results herein confirm that Fe and Ti can be concentrated via magnetic and gravity separations. As Table 5 shows, an Fe-rich product with 41.8% of Fe and a Ti-rich product with 4.3% of Ti were obtained through magnetic and gravity separations, respectively. The PRV of the Fe-rich product and the Ti-rich product was 579 $/ton and 1,124 $/ton, respectively, which are much higher than that of the feed ash (483 $/ton). As such, magnetic and gravity separations can enhance both the valuable metal recovery and economic value of the flotation tailings.

TABLE 5
Elemental contents (Ti, Fe, Cu, Zn, and Mn in %; Sc, Co, Ni, Sn, and V in mg/kg),
PRV, and PRV distributions of the magnetic (M) and 2.95 SG sink materials.

| Metals | | Ti | Sc | Fe | Cu | Zn | Mn | Co | Ni | Sn | V | Other | Total |
|---|---|---|---|---|---|---|---|---|---|---|---|---|---|
| M | Content | 0.6 | 9.6 | 41.8 | 0.12 | 0.3 | 0.2 | 284 | 496 | 173 | 94 | N/A | N/A |
| | PRV | 131.3 | 53.0 | 309.3 | 11.1 | 9.4 | 17.2 | 20.2 | 9.8 | 6.7 | 3.4 | 7.2 | 579 |
| | ($/ton) | | | | | | | | | | | | |
| | Distribution | 22.7 | 9.2 | 53.5 | 1.9 | 1.6 | 3.0 | 3.5 | 1.7 | 1.2 | 0.6 | 1.2 | 100 |
| | (%) | | | | | | | | | | | | |
| 2.95 | Content | 4.3 | 12.6 | 12.0 | 0.2 | 0.6 | 0.2 | 215 | 226 | 205 | 110 | N/A | N/A |
| sink | PRV | 870.7 | 69.2 | 88.4 | 18.5 | 21.2 | 17.0 | 15.3 | 4.5 | 7.9 | 4.0 | 7.2 | 1124 |
| | ($/ton) | | | | | | | | | | | | |
| | Distribution | 77.5 | 6.2 | 7.9 | 1.6 | 1.9 | 1.5 | 1.4 | 0.4 | 0.7 | 0.4 | 0.6 | 100 |
| | (%) | | | | | | | | | | | | |

The magnetic and gravity separations are able to successfully concentrate valuable metals, including Ti, Fe, Mn, Co, and Ni from the flotation tailings.

As also set forth in the working examples, magnetic and/or specific gravity separation enrich and/or isolate metals from a raw MSWI sample. As shown in FIG. 6, when applied to the bottom ash feed, the magnetic separation had a similar effect on the material as that of the flotation tailings (FIG. 6(a)). Fe, Mn, Co, and Ni were enriched more than twofold in magnetic fraction, which was higher than that achieved in the flotation tailings. Compared with the non-magnetic product generated from flotation tailing, the gravity separation had higher recovery values for most of the valuable elements. For example, around 60% of Ti, more than 70% of Fe, Co, and Ni were recovered into 2.95 sink product (FIG. 6(b)). After some valuable metals, such as Cu, and Zn, were selectively recovered by froth flotation, the subsequent beneficiation process can be more efficient and targeted, thus leading to the improved beneficiation performance of Fe, and Ti [51,52]. Based on the magnetic and density separation results, it is evident that nonferrous metals and titanium can be effectively beneficiated from MSWI ash, respectively.

Carbonation/Flotation to Remove Lime Particles: In some aspects, the methods of the present disclosure include steps to remove lime from MSWI ash. The high alkalinity of MSWI can result in extremely high acid consumption in the subsequent chemical leaching step. In some aspects, a certain amount of lime is present in the concentrates, particularly the Ti concentrate. It is accordingly a further option to remove lime from the valuable concentrates obtained from the MSWI ash.

Accordingly, in some aspects, the present disclosure concerns a method or use or application of carbonation and the flotation lime particles, to remove lime particles from MSWI ash. In some aspects, the methods include application of pure carbon dioxide or a gas containing carbon dioxide being introduced into a MSWI ash slurry or a slurry of a fraction from MSWI ash. In some aspects, after carbonation, a collector, such as sodium oleate, used for calcite flotation is added into the slurry. In some aspects, after conditioning for a period of time, such as 1 minute to 60 minutes, a frother, such as methyl isobutyl carbinol (MIBC), may be added into the slurry. After conditioning for a period of time, such as a little as a minute to one hour, air is introduced into the slurry, and calcite coated lime particles are floated out from the slurry.

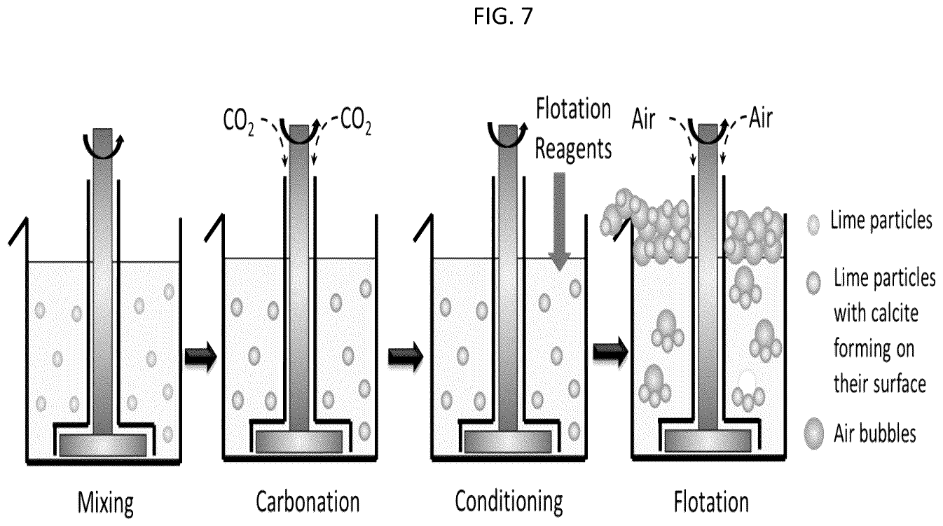

In some aspects, the lime can be removed by carbonation with CO₂ and the subsequent removal of formed calcite. Direct flotation of lime from the slurry is challenging due to its high alkalinity. In some aspects, CO₂ is introduced into the slurry prior to the addition of froth flotation reagents, which leads to the formation of calcite on the surface of lime particles and reduces the slurry pH to a weakly alkaline level. Alkaline components present in the valuable metal concentrates can thereby be effectively removed through a carbonation/flotation method. A schematic showing the carbonation/flotation process is presented in FIG. 7.

### Leachability of the Valuable Metals:

In some aspects, the present disclosure includes one or more steps of leaching metal(s) from the MSWI ash or a metal-enriched fraction therefrom. Such can include acid leaching, reductive leaching, and/or enhanced leaching, such as ultrasonic-assisted leaching, high pressure leaching, and/or mechanochemical pretreatment with leaching. FIG. 8 shows leaching recovery values of the valuable metals using 0.5 M and 1.0 M HCl as a function of time. Based on the leachability, the valuable metals should be classified into three groups: high leachability (Fe, Cu, Zn, Co, and Mn), medium leachability (Ni, Sn, and V), and low leachability (Ti and Sc). For the metals with high leachability, recoveries of greater than 80% were obtained using 0.5 M HCl within a short reaction time, such as about 1 to about 60 minutes, including about 5, 10, 15, 20, 25, 30, 35, 40, 45, 50, and 55 minutes. For the metals with medium leachability, a higher acid concentration of 1.0 M or higher is required to achieve satisfactory recovery. It should also be appreciated that for the metals with low leachability, recoveries may be limited to less than 40% even using 1.0 M HCl.

The contrast in the leachability of the valuable metals demonstrates the significance of the designed beneficiation circuits as set forth herein. The most valuable metals (Ti, Sc, Fe, Cu, and Zn) can be separated and upgraded through beneficiation. For each beneficiation product (i.e., Ti-rich, Sc-rich, Fe-rich, and Cu/Zn rich), different leaching conditions are required; for example, Cu and Zn in the Cu/Zn rich product can be leached under mild leaching conditions, however, high acid concentrations are required for the Ti-rich and Sc-rich products. Without beneficiation prior to leaching, Cu and Zn need to be leached under strong acid conditions to obtain the satisfactory recovery of Sc and Fe. In addition, after beneficiation, the valuable metals can be notably upgraded, and as such, valuable metal contents in the feed to leaching are improved. Both effects contribute to reductions in the acid concentration. Upgrading the valuable metals also increases the concentration of valuable metals while reducing the concentration of contaminant ions in leach solutions.

In some aspects, pH static leaching may be used on the MSWI ash or a fraction obtained therefrom as described herein, such as from froth floatation, density/SG sepearatino, size selection etc. In some aspects, lowering the pH can increase the amount of desired metals leached into the acid. In some aspects, the pH of the leaching solution is of from about 0.0 to about 8.0, including about 0.5, 1.0, 1.5, 2.0, 2.5, 3.0, 3.5, 4.0, 4.5, 5.0, 5.5, 6.0, 6.5, 7.0, and 7.5. In some aspects, the pH is 0.0.

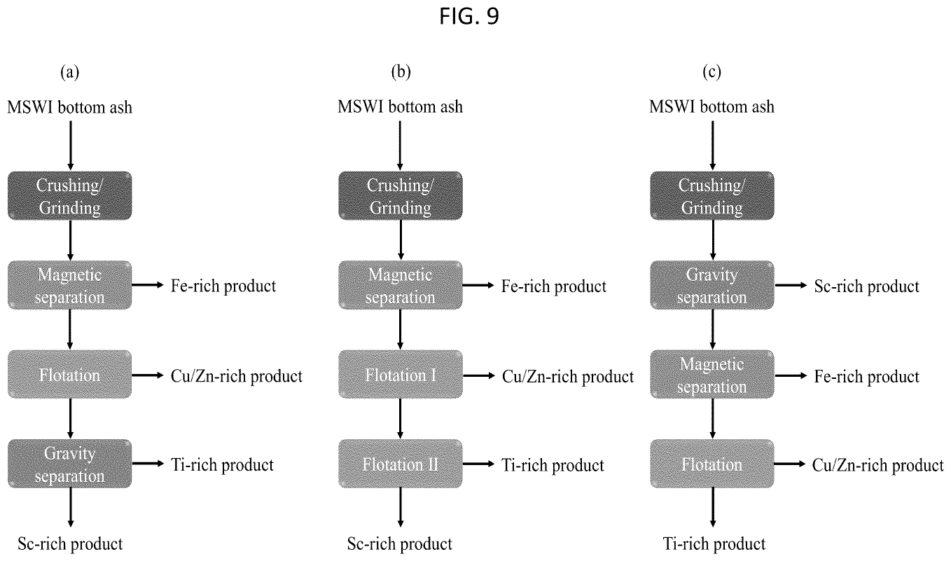

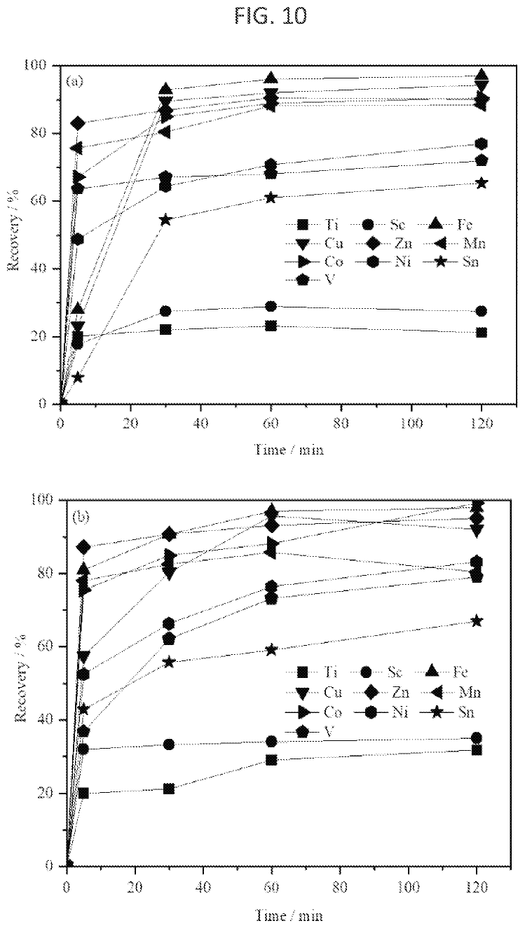

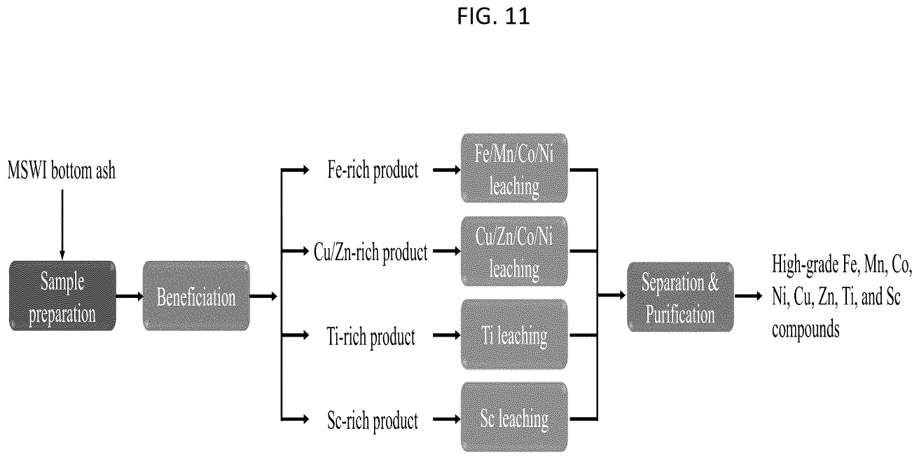

Based on the results and discussion of the beneficiation and acid leaching tests set forth in the examples, a general process circuit for producing high-grade Ti, Sc, Fe, Mn, Co, Ni, Cu, and Zn products is presented in FIG. 9. MSWI ash is first separated into different upgraded products through a beneficiation circuit. The valuable metals present in each product are then extracted under different leaching conditions, leading to leach solutions with different elemental compositions. Ultimately, high-grade valuable metal products are generated from the leach solutions through separation and purification circuits, which may include but are not limited to solvent extraction, selective precipitation, selective adsorption, and ion-exchange. Due to the inefficient beneficiation performance, V is not included in the circuit; however, given its relatively high leachability, high-grade V compounds can be produced as byproducts along with the other valuable metals in practice.

The valuable metals present in MSWI ash are relatively easy to leach, suggesting that some of the metals are oxidized into metal oxides. However, contrasts in leachability can still be observed between the different metals. In general, nonferrous metals are more leachable than titanium; thus, in this patent, normal acid leaching is used to leach the nonferrous concentrate, whereas the titanium concentrate is leached by enhanced leaching methods, such as high-pressure leaching, ultrasonic-assisted leaching, and microwave-assisted leaching. In addition, the ferrous concentrate primarily contains Fe and Mn. To facilitate the downstream purification steps, reductive leaching is used to selective leaching Mn from the concentrate, leaving Fe in the solid residue.

### Chemical Separation

In some aspects of the present disclosure, metals can be enriched and/or isolated from MSWI ash or a fraction obtained therefrom through chemical separation. In some aspects, chemical separation may include one or more of solvent extraction, ion-exchange, selective precipitation, or membrane-based isolation.

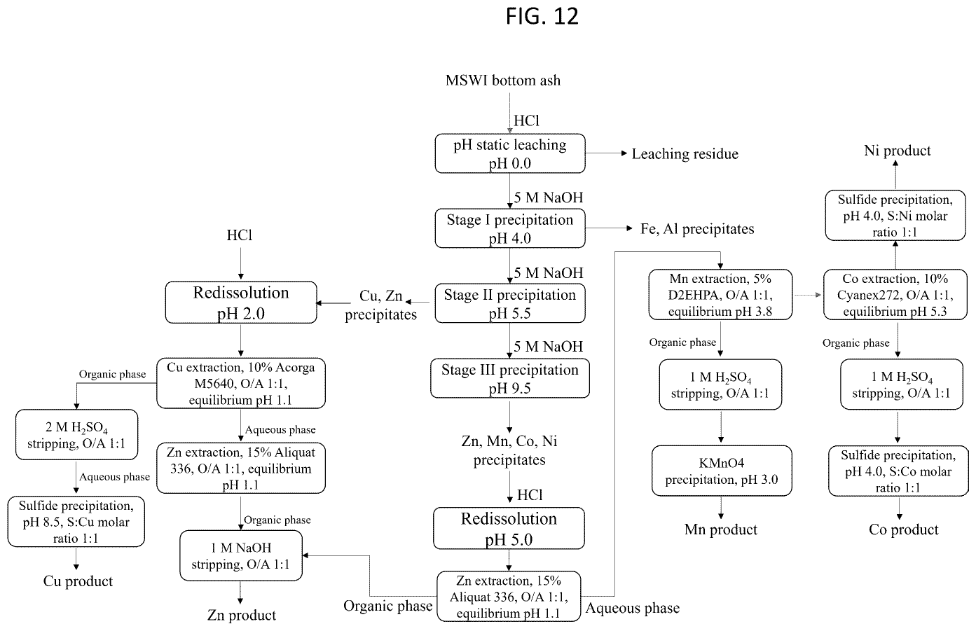

In some aspects, the chemical separation may be performed on a leachate, leach liquor, or a solution or sample obtain by leaching MSWI or a fraction obtained therefrom (see, e.g., FIG. 12). In some aspects, the chemical separation may include sequential precipitation. In some aspects, raising the pH incrementally will cause metals and impurities therein to precipitate. In some aspects, raising the pH from 0.0 to 4.5 allows Al and Fe to precipitate. Switching to a pH of about 5.5 allows for most Cu and some Zn to precipitate. Raising the pH to about 10 allows for remaining metals to precipitate, such as remaining Zn, Mn, Co, and Ni. In some aspects, the process can be repeated to further purify metals. For example, the precipitate from pH 10 can be redissolved in an acid solution and then the pH raised sequentially again. Metal(s) can then be further purified by solvent extraction. For example, Zn and/or Cu can be extracted in a first organic phase (e.g. Aliquat 336/Acorga M5640), followed by Mn, Co, and Ni in a second (e.g. D2EHPA/Cyanex 272 to extract Mn and Co), and further isolate the metal(s) still in the aqueous phase.

### EXAMPLES

To develop a process for recovering valuable metals from the material, it is critical to understand the contribution of individual metal to the overall value of the material. The elemental contents shown in Table 1 and the current standard metal prices listed in Table S1 were used to determine the PRV of metals contained within one metric ton of the MSWI bottom ash. The unit value of each metal is estimated based on multiple price references collected from authoritative online datasets or vendor quotations, and the original sources are listed in the supporting information. Some elements such as Na, K, and Ca were not considered due to their natural abundance. As Table 2 shows, PRV of the overall material was around 483 $/ton, which is primarily contributed by Ti (44.1%), Sc (28.9%), Fe (11.5%), Cu (5.3%), and Zn (3.5%). Although Mn, Co, Ni, Sn, and V only accounted for 4.7% of the PRV of the overall material, they should be considered along with Ti, Sc, Fe, Cu, and Zn as valuable elements in the recovery process, because of their criticality to high-tech products and clean energy industries [38,39].

Sieving tests were performed on MSWI ash to evaluate the size fractionation characteristics of the valuable metals contained in the MSWI bottom ash. As FIG. 2 shows, the enrichment ratios of Sc, Fe, and V showed a decreasing trend as the particle size of the MSWI bottom ash reduced, with enrichment ratios of less than 1 observed in the −400 mesh fraction. This identifies that Sc, Fe, and V are preferentially enriched in the coarse fractions. Fe-bearing phases also mainly occur in coarse fractions as Fe scraps trypically originate from the source objects such as iron cans, containers, and thin sheets, or in mineral phases like hematite as a result of the oxidization during combustion [41,42].

The enrichment ratio of Zn was approximately 1.4 in the −400 mesh fraction and less than 1.0 in the other fractions, indicating that Zn enriches in the finer fractions. Cu, Mn, Co, Ni, and Sn show enrichment ratios of greater than 1.0 in both the coarse and fine fractions, primarily due to the relatively low contents in the middle size fractions. This result identifies that the finest particles contribute a significant fraction of valuable metals, especially Cu, Zn, and Sn, which is attributable to the formation of pure solid melts as micro particles when MSW was treated in the incinerator [42,43].

Flotation tests identified that valuable metals can be concentrated and the PRV of the ash can be improved through flotation. As Table 3 shows, different collectors were used, including potassium ethylxanthate, sodium oleate, an amine collector, such as Lilaflo D817M, and sodium dodecylamine. (Lilaflo D817M is a typical kind of amine collector that has been employed to separate magnetite and coal from quartz through reverse flotation [44,45].) Na₂S is one of the most widely applied flotation reagents for mineral sulfidization [46], which was added in selected tests to regulate the surface characteristics of the oxidization forms of valuable metals. It has been reported in the literature that fine particles can deteriorate flotation performance via slime coating and high collector consumption [47]. To avoid the adverse effects, particle finer−400 mesh in the feed of FT8 test were also removed through wet sieving.

Under almost all the different flotation conditions listed in Table 3, enrichment ratios greater than 1.0 were obtained for Cu, Zn, Co, Ni, and Sn, indicating that flotation is an effective approach to enrich these valuable metals. Comparisons between the floatation conditions identified that cationic collectors, e.g., Lilaflo D817M (amione collector) and sodium dodecylamine, are more effective than sodium oleate and potassium ethylxanthate. The highest enrichment ratios of 3.2 for Cu, 2.6 for Zn, 2.4 for Co, 2.1 for Ni, and 2.3 for Sn were obtained when Na₂S was used as the regulator and an amine collector (Lilaflo D817M) as the collector without pH adjustment. Under these conditions, around 72% of Cu, 57% of Zn, 55% of Co, 47% of Ni, and 53% of Sn were recovered. A larger enrichment ratio of 4.4 for Cu but lower enrichment ratios for the other valuable metals were obtained when the floatation conditions included a mixture of potassium ethylxanthate and sodium dodecylamine. The highest enrichment ratios of 9.4 for Cu, 5.3 for Zn, 2.4 for Co, 4.7 for Ni, and 4.0 for Sn were obtained using Na₂S and sodium dodecylamine, suggesting that the elimination of fine particles from the feed considerably improved the beneficiation of the valuable metals. A concentrate containing 2.7% Cu, 2.9% Zn, 256 mg/kg Co, 930 mg/kg Ni, and 675 mg/kg Sn was obtained these conditions. The enrichment ratio of Ti, V, and Mn was close to 1.0 in all the tests, indicating that Ti, V, and Mn are not effectively beneficiated using the flotation conditions listed in Table 3. Unlike Ti, V, Mn, Cu, Zn, Co, Ni, and Sn, the enrichment ratio of Sc and Fe was below 1.0 in all the tests, and more frequently less than 0.5. This phenomenon suggests that Sc and Fe are enriched in the flotation tailings instead of the concentrates.

Elements such as Cu, Zn, Co, Ni, and Sn are effectively recovered from the MSWI bottom ash via flotation. Other elements, such as Ti and Fe were not as enriched. To increase recovery of these elements, the flotation tailings can be subjected to magnetic separation, and then, the non-magnetic product subjected to a float/sink separation a cutoff gravity of 2.95 specific gravity (SG).

As FIG. 5(a) shows, a notable enrichment of Fe, Mn, Co, and Ni was achieved in the magnetic fraction. The enrichment ratios of Fe, Mn, Co, and Ni through magnetic separation were found 3.8, 2.0, 2.8, and 3.2, respectively, indicating that these valuable elements existed as or are associated with paramagnetic or ferromagnetic fractions, which can be easily isolated using conventional magnetic field separators [48]. The enrichment ratio of Ti was only 0.5, indicating that the beneficiation of Ti cannot be achieved by magnetic separation.

The non-magnetic fraction of flotation tailings is subjected to a float/sink cutoff. Two products, 2.95 SG sink and 2.95 SG float, were obtained. As FIG. 5(b) shows, the enrichment ratio of Ti in the 2.95 SG sink product was around 3.0, indicating that the Ti in the non-magnetic fraction can be effectively recovered through gravity separation as a result of the higher bulk density of Ti-bearing materials in MSWI bottom ash [50]. Apart from Ti, all the other valuable metals except Sc were also concentrated in the 2.95 SG sink product. The test results confirmed that Fe and Ti can be concentrated via magnetic and gravity separations. As Table 4 shows, an Fe-rich product with 41.8% of Fe and a Ti-rich product with 4.3% of Ti were obtained through magnetic and gravity separations, respectively. The PRV of the Fe-rich product and the Ti-rich product was 579 $/ton and 1,124 $/ton, respectively, which are much higher than that of the feed ash (483 $/ton). As such, magnetic and gravity separations can enhance both the valuable metal recovery and economic value of the flotation tailings.

To facilitate a prospective evaluation of downstream hydrometallurgical recovery, acid leaching tests were performed on the MSWI bottom ash to determine the relative leachability of the valuable metals. FIG. 8 shows leaching recovery values of the valuable metals using 0.5 M and 1.0 M HCl as a function of time. Based on the leachability, the valuable metals can be classified into three groups: high leachability (Fe, Cu, Zn, Co, and Mn), medium leachability (Ni, Sn, and V), and low leachability (Ti and Sc). For the metals with high leachability, recoveries of greater than 80% were obtained using 0.5 M HCl within a short reaction time (e.g., 30 min). For the metals with medium leachability, a higher acid concentration of around 1.0 M is required to achieve satisfactory recovery. However, for the metals with low leachability, recoveries were less than 40% even using 1.0 M HCl.

The magnetic and gravity separations were able to successfully concentrate valuable metals, including Ti, Fe, Mn, Co, and Ni from the flotation tailings. Given the degree of separation imparted flotation pre-treatment, this tailings material is mineralogically distinct from that of the untreated MSWI bottom ash. As such, additional testing was needed to verify the utility of magnetic and gravity separations when treating raw feed. The tests were conducted on the −100 mesh sample, and the results are shown in FIG. 6. When applied to the bottom ash feed, the magnetic separation had a similar effect on the material as that of the flotation tailings (FIG. 6(a)). Fe, Mn, Co, and Ni were enriched more than twofold in magnetic fraction, which was higher than that achieved in the flotation tailings. Compared with the non-magnetic product generated from flotation tailing, the gravity separation had higher recovery values for most of the valuable elements. For example, around 60% of Ti, more than 70% of Fe, Co, and Ni were recovered into 2.95 sink product (FIG. 6(b)). After some valuable metals, such as Cu, and Zn, were selectively recovered by froth flotation, the subsequent beneficiation process would be more efficient and targeted, thus leading to the improved beneficiation performance of Fe, and Ti [51,52].

A novel method was developed to remove lime from the valuable concentrates. Direct flotation of lime from the slurry is challenging due to its high alkalinity. In the method, CO₂ is introduced into the slurry prior to the addition of flotation reagents, which leads to the formation of calcite on the surface of lime particles and reduces the slurry pH to a weakly alkaline level. Calcite flotation under weakly alkaline conditions has a long history of success in the industry. The calcite coated lime particles are expected to have similar surface characteristics as normal calcite particles. Therefore, it is expected that the alkaline components present in the valuable metal concentrates can be effectively removed through the carbonation/flotation method. A schematic showing the carbonation/flotation process is presented in FIG. 7.

Acid leaching tests were performed on the MSWI bottom ash to determine the relative leachability of the valuable metals. FIG. 8 shows leaching recovery values of the valuable metals using 0.5 M and 1.0 M HCl as a function of time. Based on the leachability, the valuable metals can be classified into three groups: high leachability (Fe, Cu, Zn, Co, and Mn), medium leachability (Ni, Sn, and V), and low leachability (Ti and Sc). For the metals with high leachability, recoveries of greater than 80% were obtained using 0.5 M HCl within a short reaction time (e.g., 30 min). For the metals with medium leachability, a higher acid concentration of around 1.0 M is required to achieve satisfactory recovery. However, for the metals with low leachability, recoveries were less than 40% even using 1.0 M HCl. The contrast in the leachability of the valuable metals indicated the importance of designing efficient beneficiation circuits. The most valuable metals (Ti, Sc, Fe, Cu, and Zn) can be separated and upgraded through beneficiation. For each beneficiation product (i.e., Ti-rich, Sc-rich, Fe-rich, and Cu/Zn rich), different leaching conditions are required; for example, Cu and Zn in the Cu/Zn rich product can be leached under mild leaching conditions, however, high acid concentrations are required for the Ti-rich and Sc-rich products. Without beneficiation prior to leaching, Cu and Zn need to be leached under strong acid conditions to obtain the satisfactory recovery of Sc and Fe.

pH static leaching tests were conducted to evaluate the leaching behavior of valuable metals and the contaminant metal ions as a function of pH (see FIG. 12). The leaching procedure was modified from the European standard (CEN/TS 14429, 2005; [20]), which has been widely used for leachability quantification of MSWI ash [21, 22]. Specifically, 10 g of dry bottom ash was suspended in 50 ml deionized water (a solid to liquid ratio (S/L) of 0.2 kg/L) in an acid-free glass beaker of 250 ml capacity, under continuously stirring by a poly tetra fluoroethylene (PTFE) coated magnetic stir bar at 600 rpm. Including the native pH of the bottom ash slurry, ten final pH values were investigated, covering a range of pH 11-0, to investigate the release of valuable metals as well as the contaminant metal ions. The pH of different suspensions was controlled by HCl solution and a benchtop electrochemistry meter (Orion Star Pro, Thermo Scientific, USA). After 3 h of stirring at 25° C., the mixtures were filtered using 2.5 μm pore size filter paper. The liquid fractions were diluted 100 times in 5% HNO3 solution for elemental concentration measurement using inductively coupled plasma mass spectrometry (ICP-MS), while the residual solids were thoroughly rinsed by deionized water before being dried at 60° C. overnight. After drying, the leaching solid residues were weighted, and 0.1 g of which was digested for elemental content analysis using HCl, HNO3, and HF.

After reaching the highest recovery of valuable metals by pH static leaching, the leach liquor was subjected to sequential precipitation test to evaluate the precipitation behaviors of valuable metals and contaminant metal ions. The tests were carried out in a 100 mL round-bottomed glass beaker equipped with a magnetic stirrer at 25° C. In the precipitation steps, 2 mL 30% H₂O₂ was first added into 80 mL leach liquor to oxidize the ferrous iron to ferric form. Then, a NaOH solution of 10 M was gradually introduced into the beaker to gradually increase the pH values. To avoid the indiscriminate precipitation caused by concentrated base solution, the mixture was kept stirring at 500 rpm for 2 min after each addition of 0.2 mL NaOH solution. The solution pH after 2 min of stirring was considered to be the final pH for the given precipitation point. The precipitate was gradually generated with the increase of pH value. Upon reaching the desired pH value, 0.5 mL of the suspension was collected from the beaker and centrifuged at 5000 rpm for 5 min. The supernatant was then diluted 100 times in 5% HNO3 solution for elemental determination. Meanwhile, NaOH solution was continuously added into the leach liquor to further raise the pH value. The precipitation test is not completed until the metal concentration of the supernatant ceases to undergo any further alterations. The precipitation recoveries of various metals were determined by the concentrations in the leach liquor and supernatants, taking the dilution effect resulted from the addition of base solution and sample collection at different pH intervals into consideration.

Based on the results and discussion of the beneficiation and acid leaching tests, a general process circuit for producing high-grade Ti, Sc, Fe, Mn, Co, Ni, Cu, and Zn products is presented in FIG. 9. MSWI ash is first separated into different upgraded products through a beneficiation circuit. The valuable metals comprised in each product are then extracted under different leaching conditions, leading to leach solutions with different elemental compositions. Ultimately, high-grade valuable metal products are generated from the leach solutions through separation and purification circuits, which may include but are not limited to solvent extraction, selective precipitation, selective adsorption, and ion-exchange. Due to the inefficient beneficiation performance, V is not included in the circuit; however, given its relatively high leachability, high-grade V compounds can be produced as byproducts along with the other valuable metals in practice.

Various modifications of the present disclosure, in addition to those shown and described herein, will be apparent to those skilled in the art of the above description. Such modifications are also intended to fall within the scope of the appended claims.

It is appreciated that all reagents are obtainable by sources known in the art unless otherwise specified.

It is also to be understood that this disclosure is not limited to the specific aspects and methods described herein, as specific components and/or conditions may, of course, vary. Furthermore, the terminology used herein is used only for the purpose of describing particular aspects of the present disclosure and is not intended to be limiting in any way. It will be also understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein. Similarly, as used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Reference is made in detail to exemplary compositions, aspects and methods of the present disclosure, which constitute the best modes of practicing the disclosure presently known to the inventors. The drawings are not necessarily to scale. However, it is to be understood that the disclosed aspects are merely exemplary of the disclosure that may be embodied in various and alternative forms. Therefore, specific details disclosed herein are not to be interpreted as limiting, but merely as a representative basis for any aspect of the disclosure and/or as a representative basis for teaching one skilled in the art to variously employ the present disclosure.

Patents, publications, and applications mentioned in the specification are indicative of the levels of those skilled in the art to which the disclosure pertains. These patents, publications, and applications are incorporated herein by reference to the same extent as if each individual patent, publication, or application was specifically and individually incorporated herein by reference.

The foregoing description is illustrative of particular embodiments of the disclosure, but is not meant to be a limitation upon the practice thereof. The following claims, including all equivalents thereof, are intended to define the scope of the disclosure.

### REFERENCES

ADDIN Mendeley Bibliography CSL_BIBLIOGRAPHY [1] Lu J, Chang Y, Poon C, Lee D. Slow pyrolysis of municipal solid waste (MSW): A review. Bioresour Technol 2020. https://doi.org/10.1016/j.biortech.2020.123615.
[2] Silva R V., de Brito J, Lynn C J, Dhir R K. Use of municipal solid waste incineration bottom ashes in alkali-activated materials, ceramics and granular applications: A review. Waste Manag 2017; 68:207-20. https://doi.org/10.1016/j.wasman.2017.06.043.
[3] Shahabuddin M, Krishna B B, Bhaskar T, Perkins G. Advances in the thermo-chemical production of hydrogen from biomass and residual wastes: Summary of recent techno-economic analyses. Bioresour Technol 2020; 299:122557. https://doi.org/10.1016/j.biortech.2019.122557.
[4] Ebrahimian F, Karimi K. Efficient biohydrogen and advanced biofuel coproduction from municipal solid waste through a clean process. Bioresour Technol 2020; 300:122656. https://doi.org/10.1016/j.biortech.2019.122656.
[5] Karamanov A, Pelino M, Salvo M, Metekovits I. Sintered glass-ceramics from incinerator fly ashes. Part II. The influence of the particle size and heat-treatment on the properties. J Eur Ceram Soc 2003; 23:1609-15. https://doi.org/10.1016/S0955-2219(02)00371-0.
[6] Cheeseman C R, Monteiro Da Rocha S, Sollars C, Bethanis S, Boccaccini A R. Ceramic processing of incinerator ash. bottom Waste Manag 2003; 23:907-16. https://doi.org/10.1016/S0956-053X(03)00039-4.
[7] Quina M J, Bontempi E, Bogush A, Schlumberger S, Weibel G, Braga R, et al. Technologies for the management of MSW incineration ashes from gas cleaning: New perspectives on recovery of secondary raw materials and circular economy. Sci Total Environ 2018; 635:526-42. https://doi.org/10.1016/J.SCITOTENV.2018.04.150.
[8] Wiles C C. Municipal solid waste combustion ash: State-of-the-knowledge. J Hazard Mater 1996; 47:325-44. https://doi.org/10.1016/0304-3894(95)00120-4.
[9] Li X, Chen Q, Zhou Y, Tyrer M, Yu Y. Stabilization of heavy metals in MSWI fly ash using silica fume. Waste Manag 2014; 34:2494-504. https://doi.org/10.1016/j.wasman.2014.08.027.
[10] Kurashima K, Matsuda K, Kumagai S, Kameda T, Saito Y, Yoshioka T. A combined kinetic and thermodynamic approach for interpreting the complex interactions during chloride volatilization of heavy metals in municipal solid waste fly ash. Waste Manag 2019; 87:204-17. https://doi.org/10.1016/J.WASMAN.2019.02.007.
[11] Haiying Z, Youcai Z, Jingyu Q. Utilization of municipal solid waste incineration (MSWI) fly ash in ceramic brick: Product characterization and environmental toxicity. Waste Manag 2011; 31:331-41. https://doi.org/10.1016/j.wasman.2010.10.017.
[12] Dou X, Ren F, Nguyen M Q, Ahamed A, Yin K, Chan W P, et al. Review of MSWI bottom ash utilization from perspectives of collective characterization, treatment and existing application. Renew Sustain Energy Rev 2017; 79:24-38. https://doi.org/10.1016/J.RSER.2017.05.044.
[13] Mary Joseph A, Snellings R, Nielsen P, Matthys S, De Belie N. Pre-treatment and utilisation of municipal solid waste incineration bottom ashes towards a circular economy. Constr Build Mater 2020; 260:120485. https://doi.org/10.1016/J.CONBUILDMAT.2020.120485.
[14] Zhao L, Zhang F S, Zhang J. Chemical properties of rare earth elements in typical medical waste incinerator in ashes China. J Hazard Mater 2008; 158:465-70. https://doi.org/10.1016/j.jhazmat.2008.01.091.
[15] Morf L S, Gloor R, Haag O, Haupt M, Skutan S, Lorenzo F Di, et al. Precious metals and rare earth elements in municipal solid waste—Sources and fate in a Swiss incineration plant. Waste Manag 2013; 33:634-44. https://doi.org/10.1016/j.wasman.2012.09.010.
[16] Funari V, Bokhari S N H, Vigliotti L, Meisel T, Braga R. The rare earth elements in municipal solid waste incinerators ash and promising tools for their prospecting. J Hazard Mater 2016; 301:471-9. https://doi.org/10.1016/j.jhazmat.2015.09.015.
[17] Yao Q, Samad N B, Keller B, Seah X S, Huang L, Lau R. Mobility of heavy metals and rare earth elements in incineration bottom ash through particle size reduction. Chem Eng Sci 2014; 118:214-20. https://doi.org/10.1016/j.ces.2014.07.013.
[18] Sabbas T, Polettini A, Pomi R, Astrup T, Hjelmar O, Mostbauer P, et al. Management of municipal solid waste incineration residues. Waste Manag 2003; 23:61-88. https://doi.org/10.1016/S0956-053X(02)00161-7.
[19] Glauser A, Weibel G, Eggenberger U. Effects of enhanced metal recovery on the recycling potential of MSWI bottom ash fractions in various legal frameworks. Waste Manag Res 2021; 39:1459-70. https://doi.org/10.1177/0734242X211038149.
[20] Ding Y, Zhao J, Liu J W, Zhou J, Cheng L, Zhao J, et al. A review of China's municipal solid waste (MSW) and comparison with international regions: Management and technologies in treatment and resource utilization. 1 Clean Prod 2021; 293:126144. https://doi.org/10.1016/J.JCLEPRO.2021.126144.
[21] Pfandl K, Küppers B, Scheiber S, Stockinger G, Holzer J, Pomberger R, et al. X-ray fluorescence sorting of non-ferrous metal fractions from municipal solid waste incineration bottom ash processing depending on particle surface properties. Waste Manag Res 2020; 38:111-21. https://doi.org/10.1177/0734242X19879225.
[22] Pfandl K, Stockinger G, Höllen D, Pomberger R. Rohstoffpotenzial von MVA-Rostaschen für Metallrückgewinnung und Karbonatisierung. Österreichische Wasser—Und Abfallwirtschaft 2018; 70:147-60. https://doi.org/10.1007/S00506-018-0464-X.
[23] Holm O, Wollik E, Johanna Bley T. Recovery of copper from small grain size fractions of municipal solid waste incineration bottom ash by means of density separation. Int J Sustain Eng 2018; 11:250-60. https://doi.org/10.1080/19397038.2017.1355415.
[24] Šyc M, Simon F G, Hykš J, Braga R, Biganzoli L, Costa G, et al. Metal recovery from incineration bottom ash: State-of-the-art and recent developments. J Hazard Mater 2020; 393. https://doi.org/10.1016/j.jhazmat.2020.122433.
[25] Holm O, Simon F G. Innovative treatment trains of bottom ash (BA) from municipal solid waste incineration (MSWI) in Germany. Waste Manag 2017; 59:229-36. https://doi.org/10.1016/J.WASMAN.2016.09.004.
[26] Rahman M A, Bakker M C M. Sensor-based control in eddy current separation of incinerator bottom ash. Waste Manag 2013; 33:1418-24. https://doi.org/10.1016/J.WASMAN.2013.02.013.
[27] Muchova L, Bakker E, Rem P. Precious metals in municipal solid waste incineration bottom ash. Water, Air, Soil Pollut Focus 2009; 9:107-16. https://doi.org/10.1007/S11267-008-9191-9.
[28] Zhu W, Chen X, Zhao A, Struble U J, Yang E H. Synthesis of high strength binders from alkali activation of glass materials from municipal solid waste incineration bottom ash. J Clean Prod 2019; 212:261-9. https://doi.org/10.1016/J.JCLEPRO.2018.11.295.
[29] Pienkoß F, Abis M, Bruno M, Grönholm R, Hoppe M, Kuchta K, et al. Heavy metal recovery from the fine fraction of solid waste incineration bottom ash by wet density separation. J Mater Cycles Waste Manag 2022; 24:364-77. https://doi.org/10.1007/S10163-021-01325-1.
[30] Back S, Ueda K, Sakanakura H. Determination of metal-abundant high-density particles in municipal solid waste incineration bottom ash by a series of processes: Sieving, magnetic separation, air table sorting, and milling. Waste Manag 2020; 112:11-9. https://doi.org/10.1016/j.wasman.2020.05.002.
[31] ASTM D6913/D6913M-17. Standard Test Methods for Particle-Size Distribution (Gradation) of Soils Using Sieve Analysis. ASTM International; 2021. https://doi.org/10.1520/D6913_D6913M-17.
[32] Ji B, Li Q, Zhang W. Leaching recovery of rare earth elements from the calcination product of a coal coarse refuse using organic acids. J Rare Earths 2022; 40:318-27. https://doi.org/10.1016/j.jre.2020.11.021.
[33] Blanc D, Gonzalez L, Lupsea-Toader M, de Brauer C. Mineralogical Evolution and Leaching Behaviour of a Heap of Bottom Ash as a Function of Time: Influence on Its Valorization. Waste and Biomass Valorization 2018; 9:2517-27. https://doi.org/10.1007/S12649-018-0444-1.
[34] Gonzalez M L, Blanc D, de Brauer C. Multi-Analytical Approach and Geochemical Modeling for Mineral Trace Element Speciation in MSWI Bottom-Ash. Waste and Biomass Valorization 2019; 10:547-60. https://doi.org/10.1007/S12649-017-0075-Y.
[35] Piantone P, Bodenan F, Chatelet-Snidaro L. Mineralogical study of secondary mineral phases from weathered MSWI bottom ash: implications for the modelling and trapping of heavy metals. Appl Geochemistry 2004; 19:1891-904. https://doi.org/10.1016/J.APGEOCHEM.2004.05.006.
[36] Bayuseno A P, Schmahl W W. Understanding the chemical and mineralogical properties of the inorganic portion of MSWI bottom ash. Waste Manag 2010; 30:1509-20. https://doi.org/10.1016/j.wasman.2010.03.010.
[37] Applegate J D. 2021 Draft List of Critical Minerals. Fed Regist 2021; 86:62199-203.
[38] Thien Nguyen T, Kim U H, Yoon C S, Sun Y K. Enhanced cycling stability of Sn-doped Li[Ni0.90Co0.05Mn0.05]O2 via optimization of particle shape and orientation. Chem Eng J 2021; 405:126887. https://doi.org/10.1016/J.CEJ.2020.126887.
[39] Hassan M, Tahsin M, Mahmood Q, Albalawi H, Somaily H H, Mera A. Study of half metallic ferromagnetism and, transport properties of Cd0.875TM0.1250 (TM=Mn, Fe, Co, Ni) alloys for spintronic applications. Mater Chem Phys 2022; 280:125801. https://doi.org/10.1016/J.MATCHEMPHYS.2022.125801.
[40] Naderizadeh Z, Khademi H, Ayoubi S. Biomonitoring of atmospheric heavy metals pollution using dust deposited on date palm leaves in southwestern Iran. Atmósfera 2016; 29:141-55.
[41] Wei Y, Shimaoka T, Saffarzadeh A, Takahashi F. Alteration of municipal solid waste incineration bottom ash focusing on the evolution of iron-rich constituents. Waste Manag 2011; 31:1992-2000. https://doi.org/10.1016/J.WASMAN.2011.04.021.
[42] Xia Y, He P, Shao L, Zhang H. Metal distribution characteristic of MSWI bottom ash in view of metal recovery. J Environ Sci (China) 2017; 52:178-89. https://doi.org/10.1016/J.JES.2016.04.016.
[43] Chimenos J M, Segarra M, Fernández M A, Espiell F. Characterization of the bottom ash in municipal solid waste incinerator. J Hazard Mater 1999; 64:211-22. https://doi.org/10.1016/S0304-3894(98)00246-5.
[44] Li Y, Nie Q, Chen J, Shen L, Li J. Effect of ammonium salt on the adsorption behavior and surface characteristics of sub-bituminous coal and silica. ACS Omega 2019; 4:10455-62. https://doi.org/10.1021/acsomega.9b00466.
[45] Zhang W, Honaker R, Li Y, Chen J. The importance of mechanical scrubbing in magnetite-concentrate reverse-flotation. Miner Eng 2014; 69:133-6. https://doi.org/10.1016/j.mineng.2014.07.020.
[46] Malghan S G. ROLE OF SODIUM SULFIDE IN THE FLOTATION OF OXIDIZED COPPER, LEAD, AND ZINC ORES. Miner Metall Process 1986; 3:158-63. https://doi.org/10.1007/BF03402654.
[47] Yu Y, Ma L, Cao M, Liu Q. Slime coatings in froth flotation: A review. Miner Eng 2017; 114:26-36. https://doi.org/10.1016/J.MINENG.2017.09.002.
[48] De Boom A, Degrez M, Hubaux P, Lucion C. MSWI boiler fly ashes: Magnetic separation for material recovery. Waste Manag 2011; 31:1505-13. https://doi.org/10.1016/J.WASMAN.2011.01.002.
[49] Krishna Alla R, Gosavi S, Gosavi S, Alla R. Titanium-A Miracle Metal in Dentistry Titanium: A Miracle Metal in Dentistry. Trends Biomater Artif Organs 2013; 27:42-6.
[50] Schabbach L M, Bolelli G, Andreola F, Lancellotti I, Barbieri L. Valorization of MSWI bottom ash through ceramic glazing process: A new technology. J Clean Prod 2012; 23:147-57. https://doi.org/10.1016/J.JCLEPRO.2011.10.029.
[51] Kalyoncu E, Burat F. Selective Separation of Coloring Impurities from Feldspar Ore by Innovative Single-stage Flotation. Https://DoiOrg/101080/0882750820211968857 2021. https://doi.org/10.1080/08827508.2021.1968857.
[52] Chunli C, Wang Weizhi, Zewei L, Chuntao W, Shuai W, Chunli C, et al. Experimental Research on Recovery of Titanium by Full Flotation from Heishan's Iron Separation Tailings. Multipurp Util Miner Resour 2018:102-5. https://doi.org/10.3969/J.ISSN.1000-6532.2018.06.021.

We claim:

1. A method to concentrate one or metals from a municipal solid waste incineration (MSWI) ash comprising at least one step selected from:
a. reducing the MSWI ash in size by crushing and sizing particles thereof from about 100 to about 400 mesh;
b. adding the MSWI ash in a froth floatation solution to separate the MSWI ash in a froth floating fraction and a tailings fraction, wherein the froth floatation solution comprises a sulfide and a cationic collector;
c. contact of the MSWI ash with a magnetic field to provide a magnetic fraction of the ash and a non-magnetic fraction of the ash;
d. adding the MSWI ash to a float/sink solution with a specific gravity of 2.4-3.0 to provide a float fraction and a sink fraction;
e. placing the MSWI ash in an aqueous solution and treating with a gas comprised of carbon dioxide to generate calcite-coated lime;
f. treating the ash with a leaching solution to provide a leachate; or
g. preparing a chemically separated fraction of the ash by solvent extraction, ion-exchange, selective precipitation, or passage through a membrane.

2. The method of claim 1, wherein at least two of the steps are performed.

3. The method of claim 1, wherein steps (c) and (d) are performed.

4. The method of claim 3, wherein the non-magnetic fraction is added to the solution of (d).

5. The method of claim 1, wherein steps (a), (b), (f), and (g).

6. The method of claim 1, wherein (e) is performed before any other step.

7. The method of claim 1, wherein the step comprises (f) and wherein the leaching solution comprises an acid.

8. The method of claim 7, wherein the leaching solution has a pH of 0.0.

9. The method of claim 8, further comprising raising the pH of the leachate to precipitate one or more metals therein.

10. The method of claim 9, wherein in the pH is raised to 3.5, 5.5, and 10 in three sequential steps, and wherein precipitated metal is isolated from the leachate with sequential step.

11. The method of claim 1, wherein the step comprises step (b).

12. The method of claim 11, wherein the cationic collector comprises a dodecylamine salt.

13. The method of claim 11, wherein the MSWI ash is prepared as a slurry in water, followed by the sequential addition of the sulfide and the cationic collector.

14. The method of claim 13, wherein the sulfide is added first to form a layer of metal sulfates.

15. The method of claim 13, wherein carbon dioxide is provided to the slurry prior to addition of the sulfide and the cationic collector to generate lime particles that can be removed and/or air is bubbled in the slurry.

16. The method of claim 1, wherein 1, wherein step (c) is performed and the non-magnetic fraction is provided into the froth floatation solution of step (b) and the tailings fraction is then added to the float/sink solution of step (d).

17. The method of claim 1, wherein the step comprises (e), wherein the MSWI ash is provided to an aqueous solution and the gas is bubbled therein.

18. The method of claim 17, wherein after carbonation of the slurry by the gas, sodium oleate is added to the slurry.

19. The method of claim 18, wherein methyl isobutyl carbinol (MIBC) is added to the slurry.
